(19) United States
(12) Patent Application Publication
(10) Pub. No.: US 2026/0196476 A1
(43) Pub. Date: Jul. 9, 2026

(54) HYDROGEN STORAGE ALLOY FOR ALKALINE STORAGE BATTERY, ALKALINE STORAGE BATTERY USING SAME FOR NEGATIVE ELECTRODE, AND VEHICLE

(71) Applicants: JAPAN METALS AND CHEMICALS CO., LTD., Tokyo (JP); TOYOTA JIDOSHA KABUSHIKI KAISHA, Toyota-chi, Aichi (JP); KABUSHIKI KAISHA TOYOTA JIDOSHOKKI, Kariya-shi, Aichi (JP)

(72) Inventors: Saki NOTOYAMA, Nishiokitama-gun (JP); Tomoki SOUMA, Nishiokitama-gun (JP); Katsuyuki KUDO, Nishiokitama-gun, Yamagata (JP); Ryoji SUZUKI, Nishiokitama-gun (JP); Takao SAWA, Nishiokitama-gun (JP); Masanobu OUCHI, Toyota-shi (JP); Hiroyuki SASAKI, Kariya-shi (JP); Ryo EGUCHI, Kariya-shi (JP); Satoshi KONO, Kariya-shi (JP); Takeou OKANISHI, Kariya-shi (JP); Kohei MANRIKI, Kariya-shi (JP); Tsukasa SUGIE, Kariya-shi (JP)

(73) Assignees: JAPAN METALS AND CHEMICALS CO., LTD., Tokyo (JP); TOYOTA JIDOSHA KABUSHIKI KAISHA, Toyota-chi, Aichi (JP); KABUSHIKI KAISHA TOYOTA JIDOSHOKKI, Kariya-shi, Aichi (JP)

(21) Appl. No.: 19/133,616

(22) PCT Filed: Oct. 30, 2023
(86) PCT No.: PCT/JP2023/039053

§ 371 Date: May 28, 2025

(30) Foreign Application Priority Data
Nov. 28, 2022 (JP) 2022-189294

(51) Int. Cl. H01M 4/24; C22C 28/00

(52) U.S. Cl. CPC H01M 4/242; C22C 28/00; C22C 2202/04; H01M 2220/20

(57) ABSTRACT

A hydrogen storage alloy that is used for an alkaline storage battery, and that has a main phase combining crystal structures of an A₂B₇-type structure, an A₅B₁₉-type structure, or an AB₃-type structure and is represented by General Formula (1): (La_{1-a-b}YₐR_{b})_{1-c}Mg_{c}Ni_{d}AlₑCr_{f}Fe_{g} (where R and the suffixes a, b, c, d, e, f, and g are as follows: R is one or both of Sm and Ce, 0<a≤0.12, 0≤b≤0.12, 0.13≤c≤0.27, 3.20≤d+e+f+g≤3.75, 0≤e≤0.14, 0≤f≤0.05, and 0≤g≤5 0.35); an alkaline storage battery that uses this alloy for a negative electrode; and a vehicle that has this alkaline storage battery as a source of electricity to be supplied to a motor.

### TECHNICAL FIELD

The present invention relates to a hydrogen storage alloy used for an alkaline storage battery, and relates particularly to a hydrogen storage alloy that is suitably used for an alkaline storage battery serving as a power source of a hybrid electric vehicle (HEV), a start-stop vehicle, etc., an alkaline storage battery that is suitable as a power source of a hybrid electric vehicle (HEV), a start-stop vehicle, etc., and a vehicle equipped with this alkaline storage battery.

### BACKGROUND ART

In recent years, secondary batteries have been widely used for, for example, mobile phones, personal computers, power tools, hybrid electric vehicles (HEVs), and pure electric vehicles (EVs), and for these applications, alkaline storage batteries are mainly used. For those alkaline storage batteries that are used in connection with vehicles such as hybrid electric vehicles (HEVs), plug-in hybrid vehicles (PHEVs), and pure electric vehicles (EVs), high output properties and high durability are particularly important. As their use expands to these applications, demands for downsizing and weight reduction of alkaline storage batteries have been growing.

Conventionally, hydrogen storage alloys with an AB₅-type crystal structure have been used for negative electrodes of alkaline storage batteries. However, downsizing and weight reduction of batteries achieved by these alloys are limited, and development of a new hydrogen storage alloy that can realize a small size and a high capacity has been desired. As solutions, Patent Literature 1 and Patent Literature 2 propose rare earth-Mg transition metal-based hydrogen storage alloys including Mg.

As an approach to realizing downsizing and weight reduction of an alkaline storage battery, for example, reducing the amount of hydrogen storage alloy used for the negative electrode is conceivable. However, reducing the amount of hydrogen storage alloy raises a new problem that the output of the alkaline storage battery decreases due to a decrease in the number of nickel active sites. To remedy this problem, Patent Literature 3 proposes an approach that raises an operating voltage by using a hydrogen storage alloy having a high hydrogen equilibrium pressure.

As hydrogen storage alloys, several rare earth-Mg—Ni-based alloys have been proposed. For example, Patent Literature 4 discloses a hydrogen storage alloy represented by a general formula: Ln₁₋ₓMgₓNi_{y}A_{z} (where Ln is at least one type of element selected from rare earth elements including Y, and from Ca, Zr, and Ti; A is at least one type of element selected from Co, Mn, V, Cr, Nb, Al, Ga, Zn, Sn, Cu, Si, P, and B; and the suffixes x, y, and Z meet the conditions of 0.05≤x≤0.25, 0<z≤1.5, and 2.8≤y+z≤4.0). In this hydrogen storage alloy, Sm is included in the aforementioned Ln at a ratio of 20 mol % or more.

Patent Literature 5 discloses, as a hydrogen storage alloy used for a negative electrode of a nickel hydrogen secondary battery, an alloy having a composition expressed by a general formula: (LaₐSm_{b}A_{c})_{1-w}Mg_{w}NiₓAl_{y}T_{z} (where A and T each represent at least one type of element selected from a group consisting of Pr, Nd, etc. and a group consisting of V, Nb, etc., respectively; the suffixes a, b, and c meet relationships expressed by a>0, b>0, 0.1>c≥0, and a+b+c=1; and the suffixes w, x, y, and z are within ranges expressed by 0.1<w≤1, 0.05≤y≤0.35, 0≤z≤0.5, 3.2≤x+y+z≤3.8).

Aiming to provide an alkaline storage battery having improved cycle characteristics and discharge characteristics, Patent Literature 6 discloses a hydrogen storage alloy having a composition expressed by a general formula: (A_{α}Ln_{1-α})_{1-β}Mg_{β}Ni_{γ-δ—ε}Al_{δ}T_{ε} (where A represents one or more types of elements that are selected from a group consisting of Pr, Nd, Sm, and Gd and include at least Sm; Ln represents at least one type of element selected from a group consisting of La, Ce, Pm, Eu, Tb, Dy, Ho, Er, Tm, Yb, Lu, Ca, Sr, Sc, Y, Ti, Zr, and Hf: T represents at least one type of element selected from a group consisting of V, Nb, Ta, Cr, Mo, Mn, Fe, Co, Zn, Ga, Sn, In, Cu, Si, P, and B; the suffixes α, β, γ, δ, and ε represent numbers that meet 0.4≤α, 0.05<β<0.15, 3.0≤γ≤4.2, 0.15≤δ≤0.30, and 0≤ε≤0.20).

Patent Literature 7 reports a hydrogen storage alloy electrode that, to enable high-rate discharge, uses hydrogen storage alloy particles of which a central diameter D50 represented by a 50% passing rate is within a range of 8 to 15 μm.

Aiming to provide a hydrogen storage alloy with excellent cycle life characteristics, Patent Literature 8 discloses a hydrogen storage alloy including a phase formed by a Gd₂Co₇-type crystal structure. The disclosed alloy is characterized in that this phase accounts for 10 weight % or more of the entire hydrogen storage alloy, and that the hydrogen storage alloy includes yttrium at a ratio of 2 mol % or more but 10 mol % or less relative to the entire hydrogen storage alloy.

Patent Literature 9 discloses a rare earth-Mg—Ni-based hydrogen storage alloy by which, even after long-term disuse of a nickel hydrogen secondary battery, a decrease in the operating voltage is mitigated and a high operating voltage can be obtained. Specifically, the hydrogen storage alloy used for a battery has a composition expressed by a general formula: (LaₐNd_{b}A_{c}D_{d})_{1-w}Mg_{w}NiₓAl_{y}T_{z}. According to this disclosure, in this formula, A, D, and T each represent at least one type of element selected from a group consisting of Sm and Gd, a group consisting of Pr, Eu, etc., and a group consisting of V, Nb, etc., respectively; the suffixes a, b, c, and d meet relationships expressed by a≥0, b≥0, c>0, 0.1>d≥0, and a+b+c+d=1; and the suffixes w, x, y, and z are within ranges expressed by 0<w≤0.25, 0.05≤y≤0.35, 0≤z≤0.5, and 3.15≤x+y+z≤3.35.

Patent Literature 10 discloses, as a hydrogen storage alloy for an alkaline storage battery that allows a cost reduction while maintaining a high output, an alloy characterized by being represented by a general formula (Re₁₋ₓYₓ)_{1-y-z}Zr_{y}Mg_{z}Ni_{a-b}Al_{b} (Re includes only La, or at least one type of element that includes La and is selected from Nd and Sm, 0<x≤0.60, 0≤y≤0.02, 0.09≤z≤0.13, 3.40≤a≤3.80, and 0.05≤b≤0.20).

Aiming to provide a nickel hydrogen secondary battery that has a high capacity and is excellent in both self-discharge characteristics and cycle life characteristics, Patent Literature 11 discloses a hydrogen storage alloy having a composition represented by a general formula: (RE₁₋ₓTₓ)_{1-y}Mg_{y}Ni_{z-a}Alₐ (where RE is at least one element selected from Y, Sc, and rare earth elements; T is at least one element selected from Zr, V, and Ca; and the suffixes x, y, z, and a indicate 0≤x, 0.05≤y≤0.35, 2.8≤z≤3.9, and 0.10≤a≤0.25, respectively). This hydrogen storage alloy has a crystal structure in which an AB₂-type sub-unit and an AB₅-type sub-unit are arranged in layers, and some of the aforementioned Ni are substituted with Cr.

Patent Literature 12 aims to provide a hydrogen storage alloy of which pulverization is mitigated, and discloses a hydrogen storage alloy in which a ratio of the strongest peak intensity that appears in a range of 2θ=310 to 330 to the strongest peak intensity that appears in a range of 2θ=41° to 44° in an X-ray diffraction measurement using Cu-Kα radiation as an X-ray source is 0.1 or less (including 0). As a specific composition, it discloses La_{1-a-b}YₐMg_{b}Ni_{c}Al_{d} (a meets 0.12≤a≤0.15; b meets 0.14≤b≤0.16; c meets 3.39≤c≤3.53; and d meets 0.13≤d≤0.17).

Aiming to provide a hydrogen storage alloy with excellent corrosion resistance and durability and a nickel hydrogen storage battery with excellent cycle life that uses this hydrogen storage alloy, Patent Literature 13 discloses a general formula (RE_{1-a-b}SmₐMg_{b}) (Ni_{1-c-d}Al_{c}M_{d})ₓ (0.3<a<0.6; 0<b<0.16; 0.1<cx<0.2; 0≤dx≤0.1; 3.2<x<3.5; RE is one or more types of elements selected from rare earth elements other than Sm and Y, with La being essential; and M is Mn and/or Co).

To provide a hydrogen storage alloy with excellent corrosion resistance and durability and a nickel hydrogen storage battery with excellent cycle life that uses this hydrogen storage alloy, Patent Literature 14 discloses a hydrogen storage alloy represented by a general formula (RE_{1-a-b}SmₐMg_{b}) (Ni_{1-c-d}Al_{c}M_{d})ₓ (0.1≤a≤0.25; 0.1<b<0.2; 0.02<cx<0.2; 0≤dx≤0.1; 3.6≤x≤3.7; RE is one or more types of elements selected from rare earth elements other than Sm, and Y; La is essential, and M is Mn and/or Co) and a nickel hydrogen battery that uses this hydrogen storage alloy.

As a hydrogen storage alloy with excellent corrosion resistance, an electrode that is formed using this hydrogen storage alloy, and an alloy powder that is used for a nickel hydrogen storage battery, Patent Literature 15 discloses a hydrogen storage alloy powder for an alkaline storage battery characterized by including a core of the hydrogen storage alloy having a composition represented by a general formula: Ln_{1-w}Mg_{w}NiₓAl_{y}T_{z} (where Ln represents at least one type of element selected from a group consisting of La, Ce, Pr, Nd, Pm, Sm, Eu, Gd, Tb, Dy, Ho, Er, Tm, Yb, Lu, Ca, Sr, Sc, Y, Ti, Zr, and Hf; T represents at least one type of element selected from a group consisting of V, Nb, Ta, Cr, Mo, Mn, Fe, Co, Ga, Zn, Sn, In, Cu, Si, P, and B; the suffixes w, x, y, and z are within ranges expressed by 0.08≤w≤0.13, 0.05<y<0.20, 0≤z≤0.5, and 3.15≤x+y+z≤3.50, respectively), and a surface layer which is integrally formed on a surface of the core and in which the concentration of aluminum is reduced compared with that in the above-described composition.

As a hydrogen storage alloy powder for an alkaline storage battery that, when applied to an alkaline storage battery, can mitigate a decrease in the operating voltage and produce a high operating voltage even after long-term disuse, particularly after long-term disuse following a charge-discharge cycle, Patent Literature 16 discloses a hydrogen storage alloy that has at least two phases containing La, Ni, and Y or a heavy rare earth element. This hydrogen storage alloy is characterized in that a first phase has a composition represented by a general formula R1ₐR2_{b}R3_{c}Ni_{d}R4ₑ (where R1 is at least one or more types of element with La being essential; R2 is at least one type of element selected from a group consisting of Y and heavy rare earth elements; R3 is Ca and/or Mg; R4 is at least one type of element selected from a group consisting of Co, Mn, and Al; and a, b, c, d, and e are numerical values that meet a+b+c=1, 0≤b≤0.3, 0≤c≤0.4, 3.0<d+e<4.0, and 0≤e≤1), and in that a second phase has a higher concentration of Y or a heavy rare earth element than the first phase and is dispersed in the first phase.

To provide a sealed nickel hydrogen storage battery with excellent high-rate discharge characteristics and charge-discharge cycle characteristics, Patent Literature 17 discloses that a layer in which a nickel content ratio is higher than that among base layer components and which has a thickness of 50 nm or larger but 400 nm or smaller is disposed on a surface of a hydrogen storage alloy powder used for a negative electrode, and that a layer in which a nickel content ratio is higher than that among the base layer components is disposed on a surface of a crack leading to a surface of the hydrogen storage alloy.

To sufficiently improve the output characteristics and the charge-discharge cycle characteristics of an alkaline storage battery in a low-temperature environment, Patent Literature 18 discloses a negative electrode for an alkaline storage battery that uses a hydrogen storage alloy expressed by a general formula Ln₁₋ₓMgₓNi_{y-a-b}AlₐM_{b} (where Ln is at least one type of element selected from rare earth elements including Y, and from Zr and Ti; M is at least one type of element selected from V, Nb, Ta, Cr, Mo, Mn, Fe, Co, Ga, Zn, Sn, In, Cu, Si, P, and B; and the conditions of 0.05≤x≤0.30, 0.05≤a≤0.30, 0≤b≤0.50, and 2.8≤y≤3.9 are met). This negative electrode for an alkaline storage battery is characterized in that: three layers, a first layer to a third layer, are stacked on a surface of a bulk phase of the hydrogen storage alloy; the first layer that is close to the bulk phase contains a larger amount of oxygen than the second layer that is located on top of the first layer, and includes an element that is soluble in an alkaline solution at a ratio of 10 atomic % or more; the second layer located on top of the first layer has a higher content ratio of Ni than the aforementioned bulk phase; and the third layer that is located on top of the second layer has a content ratio of NiO higher than a content ratio of NiO in the 15 second layer.

Patent Literature 19 discloses an alloy that can provide a nickel hydrogen secondary battery capable of achieving compatibility between high-rate discharge characteristics and life characteristics. A negative electrode of the nickel hydrogen secondary battery includes particles of a rare earth-Mg—Ni-based hydrogen storage alloy including a rare earth element, Mg, and Ni. The particles of the hydrogen storage alloy have, on their surfaces, a rare earth hydroxide that is a hydroxide of the rare earth element, and the specific surface area is 0.1 to 0.5 m²/g.

Patent Literature 20 discloses a hydrogen storage alloy that uses inexpensive Fe to achieve a lower price, higher corrosion resistance, and improved charge acceptability in a rare earth-magnesium-nickel-based hydrogen storage alloy. Specifically, it reports a hydrogen storage alloy represented by a general formula (LaₐNd_{b}A_{c}B_{d})₁₋ᵥMgᵥNi_{w}AlₓFe_{y}T_{z} (A is at least one type of element selected from Sm and Gd; B is at least one type of element selected from Pr, Eu, Tb, Dy, Ho, Er, Tm, Yb, Lu, Sc, Zr, Hf, Ca, and Y; and T is at least one type of element selected from V, Nb, Ta, Cr, Mo, Mn, Co, Ga, Zn, Sn, In, Cu, Si, P, and B). The suffixes a, b, c, and d in the general formula meet relationships 0≤a, 0≤b, 0≤c, 0≤d<0.1, a+b+c+d=1, and 0≤z≤50.5. The molar ratio v of Mg in the general formula meets 0.10≤v≤0.25; the molar ratio x of Al meets 0.10≤x≤0.20; the molar ratio y of Fe meets 0.05≤y≤0.15; and further 3.45≤w+x+y+z≤3.65 is met.

On the other hand, Non-Patent Literature 1 discloses La_{0.80-x}YₓMg_{0.20}Ni_{2.85}Mn_{0.10}Co_{0.55}Al_{0.10} (x=0, 0.05, 0.10) in which La in the hydrogen storage alloy has been substituted with Y for the purpose of improving the characteristics.

For the same purpose, Non-Patent Literature 2 discloses La_{0.63}Y_{0.20}Mg_{0.17}Ni_{3.1}Co_{0.3}Al_{0.1}.

Non-Patent Literature 3 discloses an influence of Ce on a RE-Mg—Ni-based hydrogen storage alloy (RE: rare earth element). Specifically, it discloses the following alloys:
(La_{0.5}Nd_{0.5})_{0.85}Mg_{0.15}Ni_{3.3}Al_{0.2},
(La_{0.45}Nd_{0.45}Ce_{0.1})_{0.85}Mg_{0.15}Ni_{3.3}Al_{0.2},
(La_{0.4}Nd_{0.4}Ce_{0.2})_{0.85}Mg_{0.15}Ni_{3.3}Al_{0.2}, and
(La_{0.3}Nd_{0.3}Ce_{0.4})_{0.85}Mg_{0.15}Ni_{3.3}Al_{0.2}, and reports a result of evaluating them.

Non-Patent Literatures 4 and 5 report a hydrogen storage alloy represented by Mm_{0.83}Mg_{0.17}Ni_{2.94-x}Al_{0.17}Co_{0.2}Feₓ (0≤x≤0.2).

Non-Patent Literature 6 reports a hydrogen storage alloy represented by La_{0.7}Mg_{0.3}Co_{0.45}Ni_{2.55-x}Feₓ.

Non-Patent Literature 7 reports a hydrogen storage alloy represented by La_{0.80}Mg_{0.20}Ni_{2.85}Al_{0.11}M_{0.53} (M=Ni, Si, Cr, Cu, Fe).

Non-Patent Literature 8 reports characteristics of a hydrogen storage alloy represented by La₂Ni_{6.9-x}Al_{0.1}Feₓ (0≤x≤2.1).

### CITATION LIST

### Patent Literature

Patent Literature 1: Japanese Patent Laid-Open No. 11-323469
Patent Literature 2: International Publication No. WO 01/048841
Patent Literature 3: Japanese Patent Laid-Open No. 2005-032573
Patent Literature 4: Japanese Patent Laid-Open No. 2009-074164
Patent Literature 5: Japanese Patent Laid-Open No. 2009-108379
Patent Literature 6: Japanese Patent Laid-Open No. 2009-138220
Patent Literature 7: Japanese Patent Laid-Open No. 2000-182608
Patent Literature 8: International Publication No. WO 2007/23901
Patent Literature 9: Japanese Patent Laid-Open No. 2009-228096
Patent Literature 10: Japanese Patent Laid-Open No. 2013-134903
Patent Literature 11: Japanese Patent Laid-Open No. 2014-026844
Patent Literature 12: Japanese Patent Laid-Open No. 2017-532446
Patent Literature 13: Japanese Patent Laid-Open No. 2016-069691
Patent Literature 14: Japanese Patent Laid-Open No. 2016-069692
Patent Literature 15: Japanese Patent Laid-Open No. 2014-114476
Patent Literature 16: Japanese Patent Laid-Open No. 2010-080291
Patent Literature 17: Japanese Patent Laid-Open No. 2004-247288
Patent Literature 18: Japanese Patent Laid-Open No. 2010-108910
Patent Literature 19: Japanese Patent Laid-Open No. 2016-012443
Patent Literature 20: Japanese Patent Laid-Open No. 2011-014258

### Non-Patent Literature

Non-Patent Literature 1: L. Zhiping et al., J. Rare Earth 33 p 397 (2015)
Non-Patent Literature 2: Z. J. Gao et al., J. Taiwan Institute Chem. Engineers 89 p 183 (2018)
Non-Patent Literature 3: S. Yasuoka et al., J. Power Sources 346 p 56 (2017)
Non-Patent Literature 4: Tiejun Meng et al., Batteries 2, (2016) 34
Non-Patent Literature 5: Tiejun Meng et al., Batteries 3, (2017) 28
Non-Patent Literature 6: Yang-huan Zhang et al., Materials Characterization 61 (2010) 305
Non-Patent Literature 7: X U Guochang et al., J. Rare Earth 27 (2009) 250
Non-Patent Literature 8: Hideaki Sodeyama et al.: Ibaraki District Conference p. 137 (co-hosted by Kanto Branch of The Japan Society of Mechanical Engineers and The Japan Society of Precision Engineering, issued on Sep. 28, 2007)

### SUMMARY OF INVENTION

### Technical Problem

However, in the above-described technologies disclosed in Patent Literature 1 and Patent Literature 2, the alloys have not been optimized enough for the batteries to be installed in hybrid electric vehicles.

In the technology disclosed in Patent Literature 3, a new problem arises that using a hydrogen storage alloy having a high hydrogen equilibrium pressure causes a decrease in charge-discharge cycle life.

In the technology disclosed in Patent Literature 4, while the alloy includes a relatively large amount of Sm and thus uses a more inexpensive element than Pr and Nd, this technology cannot provide a hydrogen storage alloy that is inexpensive and has excellent durability.

In the technology disclosed in Patent Literature 5, the alloy includes relatively large amounts of La and Sm and thus uses more inexpensive elements than Pr and Nd as main components, but this technology cannot provide a hydrogen storage alloy that is inexpensive and has excellent durability. In particular, in the examples of implementation, Zr is mentioned as essential and, as a B/A ratio, only 3.6 is disclosed. While this literature says that the hydrogen equilibrium pressure that has been reduced due to the increased content of La is raised to such a level that the alloy is usable for a battery, setting a composition rich in inexpensive La is often inadequate.

The alkaline storage battery using the hydrogen storage alloy disclosed in patent Literature 6 falls short of achieving compatibility among the three characteristics of a small size, a high output, and durability, in other words, between the discharge characteristics and the cycle life characteristics, that are challenges for on-board applications, and the alloy is inadequate as a hydrogen storage alloy for on-board alkaline storage batteries.

The hydrogen storage alloy disclosed in Patent Literature 7 is an AB₅ alloy (MmNi_{4.0}Co_{0.4}Mn_{0.3}Al_{0.3}). While the discharge characteristics are improved by pulverization, putting this alloy into practical use for on-board applications is difficult in terms of durability etc., and further characteristics improvement is needed.

The hydrogen storage alloy disclosed in Patent Literature 8 contains a relatively large amount of Y at 2 to 10 mol % of the hydrogen storage alloy, which makes it costly. Moreover, pulverization accompanying hydrogen storage and desorption tends to intensify and consequently corrosion progresses, suggesting that the durability improving effect is not sufficient.

While the hydrogen storage alloy disclosed in Patent Literature 9 aims mainly to mitigate a decrease in the operating voltage after long-term disuse, the fundamental cycle life and discharge capacity are not balanced well enough and, moreover, the cost of the constituent rare earth elements is high.

While the hydrogen storage alloy disclosed in Patent Literature 10 aims for a high output by containing Y as essential, it fails to achieve a sufficient cost reduction. Moreover, the discharge capacity is not sufficiently increased, so that when the alloy is applied to a battery, the battery does not have adequate characteristics and, although an output at low temperatures can be secured, it faces a challenge in terms of cycle life as well.

While the hydrogen storage alloy disclosed in Patent Literature 11 aims to realize a nickel hydrogen battery that has a high capacity and is excellent in both self-discharge characteristics and cycle life characteristics, it falls short of realizing a high capacity and nevertheless needs further characteristics improvement in cycle life characteristics as well.

While the hydrogen storage alloy disclosed in Patent Literature 12 aims for high durability by mitigating pulverization, the specific composition includes a large amount of Y. Thus, this alloy faces a challenge in terms of cost, as well as a challenge in terms of cycle life characteristics as pulverization during hydrogen storage and desorption progresses, which makes further characteristics improvement necessary.

While the hydrogen storage alloy disclosed in Patent Literature 13 aims to improve the charge-discharge cycle characteristics by improving the corrosion resistance and the durability, the cycle characteristics achieved by the disclosed hydrogen storage alloy including a relatively large amount of Sm are still inadequate, and further characteristics improvement, including durability improvement, is needed.

The hydrogen storage alloy disclosed in Patent Literature 14 aims to improve the cycle life, but the alloy is inadequate for improving the battery characteristics from the viewpoint of the balance with the discharge capacity, and thus needs further characteristics improvement.

While the hydrogen storage alloy disclosed in Patent Literature 15 aims to improve the charge-discharge cycle characteristics by improving the corrosion resistance and the durability, it is not easy to form the second phase in which the concentration of Y or a heavy rare earth element is controlled, so that battery characteristics that are actually effective cannot be obtained.

While the hydrogen storage alloy disclosed in Patent Literature 16 aims to improve the charge-discharge cycle characteristics by improving the corrosion resistance and the durability, the disclosed alloy includes Nd and Pr and is relatively costly. Even when the surface state is controlled by performing an alkaline treatment or an acidic treatment, adequate cycle characteristics and rate characteristics cannot be obtained.

While the hydrogen storage alloy shown in Patent Literature 17 aims to improve the output characteristics and the charge-discharge cycle characteristics at low temperatures, even when the surface state is controlled by performing the alkaline treatment or the acidic treatment disclosed in this patent, adequate cycle characteristics cannot be obtained, and thus further characteristics improvement is needed.

The hydrogen storage alloy disclosed in Patent Literature 18 aims to improve the output and the charge-discharge cycle characteristics at low temperatures. The surface state of the relatively inexpensive hydrogen storage alloy is controlled by performing a heating treatment on the surfaces of the alloy particles in air. While the low-temperature characteristics are said to be favorable, the capacity and the cycle characteristics are still not balanced well enough, and further characteristics improvement is needed.

The hydrogen storage alloy used in Patent Literature 19 aims to improve the charge-discharge cycle characteristics by improving the corrosion resistance and the durability. While it is intended to achieve compatibility between the rate characteristics and the life characteristics with a limited specific surface area, the disclosed alloy including a large amount of Sm has inadequate durability after the alkaline treatment and thus needs further characteristics improvement.

While the technology disclosed in Patent Literature 20 is characterized by the use of inexpensive Fe, the studies are based on an alloy including expensive Nd. Consequently, the alloy cannot be inexpensive, and the durability also needs further improvement.

As for the hydrogen storage alloy disclosed in Non-Patent Literature 1, the cycle characteristics are still inadequate, and since a certain amount of Co is included, the cost is another issue to consider.

The hydrogen storage alloy disclosed in Non-Patent Literature 2 has the lowest effect among rare earths in which La has been similarly substituted, and needs further characteristics improvement.

Further, Non-Patent Literature 3 says in conclusion that a rare earth-Mg—Ni-based alloy including Ce turned out to deteriorate significantly in a battery due to its low hydrogen storage and desorption capacities and further to its proneness to pulverization as a result of repeated hydrogen storage and desorption.

Non-Patent Literatures 4 and 5 report about Mm_{0.83}Mg_{0.17}Ni_{2.94-x}Al_{0.17}Co_{0.2}Feₓ (0≤x≤0.2) from the material characteristics to the battery characteristics. However, the cycle characteristics of the hydrogen storage alloy disclosed in Non-Patent Literatures 4 and 5 are inadequate for practical use and, moreover, this alloy contains Co and is not inexpensive, which makes it necessary to make a further cost reduction and high durability compatible with each other.

While Non-Patent Literature 6 discloses the characteristics of La_{0.7}Mg_{0.3}Co_{0.45}Ni_{2.55-x}Feₓ (0≤x≤0.4), the cycle characteristics are inadequate and further characteristics improvement is needed for practical use.

As for the alloy La_{0.80}Mg_{0.20}Ni_{2.85}Al_{0.11}M_{0.53} (M=Ni, Si, Cr, Cu, Fe) disclosed in Non-Patent Literature 7, the discharge capacity is low and the cycle life characteristics are not adequate, and thus characteristics improvement is desired.

As for the alloy La₂Ni_{6.9-x}Al_{0.1}Feₓ (0≤x≤2.1) disclosed in Non-Patent Literature 8, while the alloy itself is inexpensive, the characteristics presented regarding the alloy are only data on a gas-solid phase reaction relating to hydrogen storage and desorption. Therefore, the alloy disclosed in Non-Patent Literature 8 is an alloy that exhibits only inadequate characteristics as a hydrogen storage alloy for an alkaline storage battery. From these technical viewpoints, an inexpensive hydrogen storage alloy that has favorable characteristics as an alloy for a battery has been needed.

The present invention has been developed in view of these problems faced by the conventional technologies, and an object thereof is to provide a hydrogen storage alloy particularly suitable for an on-board nickel hydrogen battery (alkaline storage battery), a battery using this alloy, and further a vehicle equipped with this battery.

### Solution to Problem

To achieve the above object, as a hydrogen storage alloy for a negative electrode of an alkaline storage battery, an alloy is used that has a crystal structure of which the main phase combines the crystal structures of an A₂B₇-type structure, an A₅B₁₉-type structure, and an AB₃-type structure, and that has a specific component composition containing Y (rare earth element). In addition, Fe substitution is used to achieve a low cost and significantly improve the charge-discharge cycle life characteristics. Thus, the discharge capacity characteristics and the charge-discharge cycle life characteristics of the alkaline storage battery can be made compatible with each other with a good balance at a low cost. This finding leads to the development of the present invention.

The present invention is, firstly, a hydrogen storage alloy used for an alkaline storage battery. This hydrogen storage alloy has a main phase combining the crystal structures of an A₂B₇-type structure, an A₅B₁₉-type structure, and an AB₃-type structure and meets conditions of General Formula (1) below:

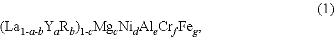

where R and the suffixes a, b, c, d, e, f, and g are as follows:
R: one or both of Sm and Ce,

$$\begin{matrix}0 < a \leq 0.12 , \\ 0 \leq b \leq 0.12 , \\ 0.13 \leq c \leq 0.27 , \\ 3.2 \leq d + e + f + g \leq 3.75 , \\ 0 \leq e \leq 0.14 , \\ 0 \leq f \leq 0.05 , and \\ 0 \leq g \leq 0.35 .\end{matrix}$$

The hydrogen storage alloy for an alkaline storage battery in which General Formula (1) further meets the following condition can be a more preferable solution:
the suffixes a, b, c, d, e, f, and g in General Formula (1) are as follows:

$$\begin{matrix}0 < a \leq 0.10 , \\ 0 < b \leq 0.10 , \\ 0.14 \leq c \leq 0.26 , \\ 3.25 \leq d + e + f + g \leq 3.7 , \\ 0 \leq e \leq 0.13 , \\ 0 \leq f \leq 0.04 , and \\ 0 < g \leq 0.30 .\end{matrix}$$

The hydrogen storage alloy for an alkaline storage battery according to the present invention specified as follows can be a more preferable solution:
(a) The hydrogen storage alloy has a hydrogen storage capacity H/M (H is the number of atoms of hydrogen, M is the number of atoms of metal) of 0.94 or more when a hydrogen pressure is applied up to 1 MPa at 80° C., and a hydrogen pressure P0.5 when the hydrogen storage capacity H/M during hydrogen desorption is 0.5 is 0.025 MPa or more but 0.12 MPa or less;
(b) The hydrogen storage alloy of which a particle size has been adjusted to be within a range of 150 μm or more but 1 mm or less has a volume mean particle diameter MV of 75 μm or more after repeated hydrogen storage and desorption,
the volume mean particle diameter MV being measured after repeating five times a cycle in which, for hydrogen storage, a hydrogen pressure is applied up to 3 MPa at 80° C. and held for one hour and, for hydrogen desorption, evacuation is performed and the pressure is reduced to or below 0.01 MPa at 80° C. and held for one hour;
(c) In hydrogen storage-desorption characteristics at 80° C. of the hydrogen storage alloy, a value calculated as a plateau slope B during hydrogen desorption after storage that is represented by Relational Expression (A) below is within a range of 1.3 or more but 3.0 or less:

$$\begin{matrix}[ Mathematical Formula 1 ] & \\ Plateau slope B = [ log ( P 0.7 / P 0.3 ) ] / 0.4 , & ( A )\end{matrix}$$

where P0.7 is a hydrogen pressure [MPa] when the hydrogen storage capacity (H/M)=0.7, and P0.3 is a hydrogen pressure [MPa] when the hydrogen storage capacity (H/M)=0.3;
(d) In an X-ray diffraction measurement of the hydrogen storage alloy using Cu-Kα radiation as an X-ray source, a ratio ζ/ε of diffraction intensity ζ of the (101) plane of an AB₅ phase to diffraction intensity ε of a strongest diffraction peak present in a range of a diffraction angle 2θ of 40 to 450 is 0.08 or less;
(e) In the hydrogen storage alloy, a layer of an oxide or a hydroxide containing Y is present on at least part of a surface of the hydrogen storage alloy;
(f) In the hydrogen storage alloy, the layer of an oxide or a hydroxide containing Y that is present on at least part of the surface of the hydrogen storage alloy has a thickness of 500 nm or smaller where the layer is in close contact with surfaces of alloy particles.
(g) An oxide or a hydroxide that is present on at least part of the surface of the hydrogen storage alloy is composed mainly of a rare earth element included in the hydrogen storage alloy;
(h) A BET specific surface area of the hydrogen storage alloy in which an oxide or a hydroxide is present on at least part of the surface of the hydrogen storage alloy is more than 0.5 m²/g;
(i) Further, a pore volume is 0.013 cm³/g or less and a mean pore diameter is 40 nm or less.

The present invention provides, secondly, an alkaline storage battery that uses any one of the above-described hydrogen storage alloys for a negative electrode, and that is either a battery that is installed in a hybrid electric vehicle having a motor as a drive source and supplies electricity to the motor, or a battery that is installed in an automobile having a start-stop function that starts an engine by a starter motor, and supplies electricity to the starter motor.

The present invention provides, thirdly, a vehicle that has, as a source of electricity to be supplied to a motor, an alkaline storage battery that uses any one of the above-described hydrogen storage alloys for a negative electrode.

### Advantageous Effects of Invention

The hydrogen storage alloy for an alkaline storage battery and the alkaline storage battery using this hydrogen storage alloy according to the present invention have high output density, and are particularly excellent in charge-discharge cycle life characteristics (durability) and therefore excellent in discharge capacity characteristics, which allows for sufficiently high-rate discharge also under on-board use conditions.

The hydrogen storage alloy for an alkaline storage battery according to the present invention has specific hydrogen storage characteristics. The mean particle diameter of alloy particles pulverized from the hydrogen storage alloy for an alkaline storage battery after repeated hydrogen storage and desorption is within a predetermined range. The AB₅ phase is controlled to be a predetermined amount or less. As such, this hydrogen storage alloy is improved in durability while maintaining the electric characteristics, and is therefore preferable.

That is, the hydrogen storage alloy for an alkaline storage battery according to the present invention can reduce the likelihood that the alloy itself develops cracks under conditions such as hydrogen storage and desorption and that the cracking intensifies and leads to pulverization.

Further, in the hydrogen storage alloy for an alkaline storage battery according to the present invention, an oxide layer or a hydroxide layer containing Y or composed mainly of a rare earth element comes into close contact with alloy particles as a surface layer. Thus, the amount of Al that improves corrosion resistance can be reduced and, by extension, the discharge capacity of the alkaline storage battery can be increased.

That is, the surface layer formed on at least part of the surface of the hydrogen storage alloy has excellent alkaline corrosion resistance as it is composed of a hydroxide or an oxide that is formed mainly by an element such as Y or a rare earth element that constitutes a part of the alloy.

In addition, this surface layer formed on the surface of the hydrogen storage alloy has a small pore volume and a small mean pore diameter (size), which reduces the probability of occurrence of cracks and can thus further enhance the corrosion resistance of the hydrogen storage alloy.

The alkaline storage battery according to the present invention can achieve downsizing and weight reduction, and when this alkaline storage battery is installed in a vehicle, such as an automobile, a hybrid electric vehicle (HEV) etc. that has high kinematic performance and high fuel efficiency can be provided.

### BRIEF DESCRIPTION OF DRAWINGS

FIG. 1 is a partially cutaway perspective view illustrating an alkaline storage battery that uses a hydrogen storage alloy of the present invention.

FIG. 2 is one example of PCT characteristics relating to the hydrogen storage alloy of the present invention.

FIG. 3 is one example of an X-ray diffraction measurement result relating to the hydrogen storage alloy of the present invention.

### DESCRIPTION OF EMBODIMENTS

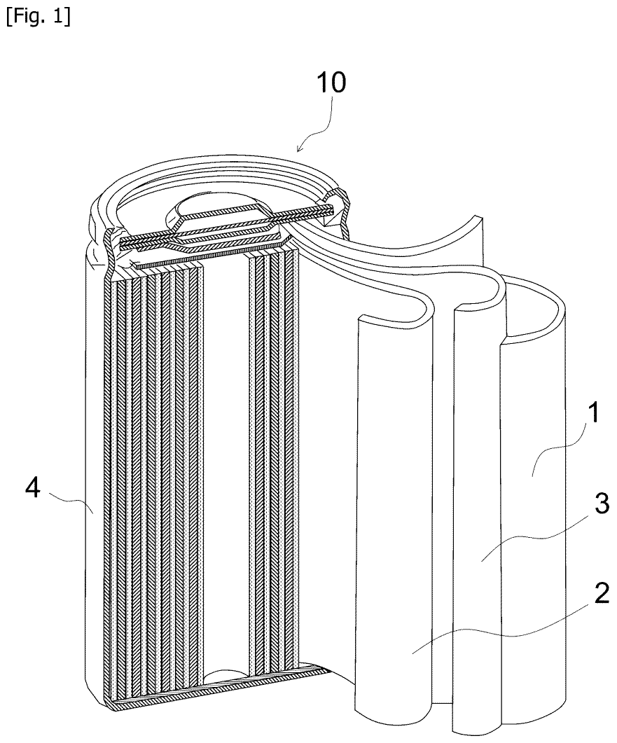

In the following, an embodiment according to the present invention will be described. An alkaline storage battery using a hydrogen storage alloy according to the embodiment will be described based on FIG. 1. FIG. 1 is a partially cutaway perspective view showing one example of the battery. As shown in FIG. 1, an alkaline storage battery 10 is a storage battery that includes, inside a casing 4, a group of electrodes consisting of a nickel positive electrode 1 including nickel hydroxide (Ni(OH)₂) as a main positive-electrode active material, a negative electrode 2 including a hydrogen storage alloy that uses the hydrogen storage alloy (MH) according to the embodiment as a negative-electrode active material, and a separator 3, along with an electrolyte layer (not shown) filled with an alkaline electrolytic solution.

The alkaline storage battery 10 is classified as a so-called nickel-metal hydride battery (Ni-MH battery; hereinafter also referred to as “nickel hydrogen battery”), in which the following reactions occur.

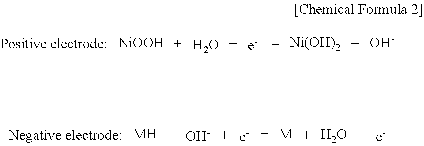

### [Hydrogen Storage Alloy]

In the following, the hydrogen storage alloy used for the negative electrode of the alkaline storage battery according to the embodiment will be described. The hydrogen storage alloy for an alkaline storage battery (hereinafter also referred to as “hydrogen storage alloy”) according to the embodiment is a hydrogen storage alloy used for an alkaline storage battery. This hydrogen storage alloy is characterized by having a main phase that combines the crystal structures of an A₂B₇-type structure, an A₅B₁₉-type structure, and an AB₃-type structure, and by being represented by the following General Formula (1):

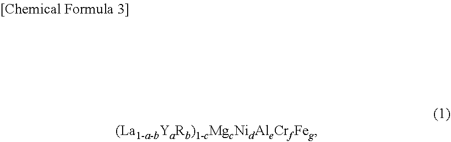

where R and the suffixes a, b, c, d, e, f, and g are as follows:
R: one or both of Sm and Ce,

$$\begin{matrix}0 < a \leq 0.12 , \\ 0 \leq b \leq 0.12 , \\ 0.13 \leq c \leq 0.27 , \\ 3.2 \leq d + e + f + g \leq 3.75 , \\ 0 \leq e \leq 0.14 , \\ 0 \leq f \leq 0.05 , and \\ 0 \leq g \leq 0.35 .\end{matrix}$$

Here, the crystal structures of the A₂B₇-type structure, the A₅B₁₉-type structure, and the AB₃-type structure are a Ce₂Ni₇ type and a Gd₂Co₇ type; a Pr₅Co₁₉ type and a Ce₅Co₁₉ type; and a CeNi₃ type and a PuNi₃ type, respectively.

In this embodiment, it is preferable that the hydrogen storage alloy be a hydrogen storage alloy for an alkaline storage battery of which General Formula (1) further meets the following condition:
the suffixes a, b, c, d, e, f, and g in General Formula (1) are as follows:

$$\begin{matrix}0 < a \leq 0.10 , \\ 0 < b \leq 0.10 , \\ 0.14 \leq c \leq 0.26 , \\ 3.25 \leq d + e + f + g \leq 3.7 , \\ 0 \leq e \leq 0.13 , \\ 0 \leq f \leq 0.04 , and \\ 0 < g \leq 0.30 .\end{matrix}$$

When used as a negative electrode of an alkaline storage battery, the hydrogen storage alloy represented by General Formula (1) imparts high discharge capacity and charge-discharge cycle life characteristics to the alkaline storage battery. Thus, the hydrogen storage alloy represented by General Formula (1) contributes to achieving downsizing, weight reduction, and durability enhancement of the alkaline storage battery.

In the following, reasons for restricting the component composition of the hydrogen storage alloy according to the embodiment will be described.

Rare earth element: La_{1-a-b}YₐR_{b} (where 0<a≤0.12, 0≤b≤0.12, preferably 0<a≤0.10, 0<b≤0.10)

The hydrogen storage alloy according to the embodiment contains rare earth elements as elements of the component A of the A₂B₇-type structure, the A₅B₁₉-type structure, and the AB₃-type structure. Of the rare earth elements, the two elements of La and Y are essential as basic components for providing a hydrogen storage capability. As La and Y are different in atomic radius, by using the ratio between these components, the hydrogen equilibrium pressure can be controlled and the hydrogen equilibrium pressure proportional to the battery voltage can be arbitrarily set. The value a of the atomic ratio of Y among the rare earth elements is within a range exceeding 0 but not exceeding 0.12.

When the value a is within this range, a hydrogen equilibrium pressure appropriate for an alkaline storage battery can be easily set, and favorable corrosion resistance and characteristics less prone to pulverization of the hydrogen storage alloy can be obtained. As a result, high durability of the alkaline storage battery can be obtained.

When the value a exceeds 0.12, pulverization of the hydrogen storage alloy accompanying hydrogen storage and desorption progresses, so that despite the corrosion resistance improving effect, the durability of the alkaline storage battery decreases gradually. The value a is preferably 0.10 or less and more preferably 0.003 or more. Y plays a major role in improving the durability of the hydrogen storage alloy by being present as an oxide or a hydroxide inside a surface layer that is formed by an oxide layer or a hydroxide layer and present on at least part of the surface of the hydrogen storage alloy.

On the other hand, R is one or both of Ce and Sm and, along with Y, contributes to controlling the hydrogen equilibrium pressure and improving the corrosion resistance of the hydrogen storage alloy. The value b of the total amount of the atomic ratio of R among the rare earth elements is within a range including 0 and not exceeding 0.12. When control of the hydrogen equilibrium pressure and the durability with Y and R in combination are considered, if the value b exceeds 0.12, pulverization of the hydrogen storage alloy accompanying hydrogen storage and desorption intensifies, which may result in reduced durability of the alkaline storage battery. The value b is preferably 0.10 or less and more preferably 0.005 or more.

It is preferable that R be essential along with Y, i.e., that one or both of Ce and Sm be essential, and it is more preferable that particularly Ce be used. In that case, it is preferable that the value b be 0.10 or less in controlling the characteristics including the hydrogen storage-desorption characteristics of the hydrogen storage alloy that are relevant to the battery characteristics.

With a composition high in La, the discharge capacity of the alkaline storage battery becomes high, and when La is combined with another element, the discharge capacity characteristics of the alkaline storage battery further improve. While Pr and Nd are not positively used as the rare earth elements, these may be contained at an unavoidable-impurity level.

Mg: Mg_{c} (where 0.13≤c≤0.27, preferably 0.14≤c≤0.26)

Mg is an essential element in this embodiment that constitutes an element of the component A of the A₂B₇-type structure, the A₅B₁₉-type structure, and the AB₃-type structure. Mg contributes to improving the discharge capacity characteristics and the charge-discharge cycle life characteristics of an alkaline storage battery that uses the hydrogen storage alloy. The value c representing the atomic ratio of Mg in the component A is within a range of 0.13 or more but 0.27 or less.

When the value c is less than 0.13, the hydrogen desorption capability of the hydrogen storage alloy degrades, so that the discharge capacity of the alkaline storage battery decreases.

On the other hand, when the value c exceeds 0.27, particularly pulverization of the hydrogen storage alloy accompanying hydrogen storage and desorption intensifies, so that the charge-discharge cycle life characteristics, i.e., the durability of the alkaline storage battery degrades. The value c is preferably within a range of 0.14 or more but 0.26 or less.

### Ni: Ni_{d}

Ni is a main element of the component B of the A₂B₇-type structure, the A₅B₁₉-type structure, and the AB₃-type structure. The value d of the atomic ratio of Ni to the component A will be described later.

Al: Alₑ (where 0≤e≤0.14 when Fe is Essential, 0.03≤e≤0.13 when Fe is not Essential)

Al is an element that is contained as an element of the component B of the A₂B₇-type structure, the A₅B₁₉-type structure, and the AB₃-type structure. Al is effective in adjusting the hydrogen equilibrium pressure relevant to the battery voltage and can improve the corrosion resistance, and thus has an effect of improving the durability of the hydrogen storage alloy, i.e., an effect on the charge-discharge cycle life characteristics of the alkaline storage battery.

To reliably exert these effects, the value e representing the atomic ratio of Al relative to the component A is within a range of 0.03 or more but 0.14 or less.

When the value e is less than 0.03, the corrosion resistance of the hydrogen storage alloy becomes inadequate, and consequently the charge-discharge cycle life characteristics of the alkaline storage battery become inadequate.

On the other hand, when the value e exceeds 0.14, the discharge capacity of the alkaline storage battery decreases, and pulverization of the hydrogen storage alloy accompanying hydrogen storage and desorption progresses, leading to a problem with its durability. A preferable value e is within a range of 0.04 or more but 0.13 or less.

On the other hand, in the case where Fe is contained as an essential element for the component B of the hydrogen storage alloy, the corrosion resisting effect of the hydrogen storage alloy imparted by Al can be realized by Fe. Therefore, the value e is within a range of 0 or more but 0.13 or less.

Thus, in the case where the hydrogen storage alloy according to the embodiment is a powder composed of fine-diameter alloy particles, the content of Al included in the alloy on a smaller side in the range of the embodiment suffices. Therefore, the content of Al included in the hydrogen storage alloy can be reduced, and the discharge capacity of the alkaline storage battery can be increased accordingly.

Cr: Cr_{f} (where 0≤f≤0.05, Preferably 0≤f≤0.04)

Cr is an element that is contained as an element of the component B of the A₂B₇-type structure, the A₅B₁₉-type structure, and the AB₃-type structure. Cr is effective in adjusting the hydrogen equilibrium pressure relevant to the battery voltage, and, along with Al, contributes to improving the corrosion resistance of the hydrogen storage alloy. In particular, Cr has an effect of improving the durability of the alkaline storage battery, i.e., an effect on the charge-discharge cycle life characteristics of the alkaline storage battery. To reliably exert these effects, the value f representing the atomic ratio of Cr relative to the component A is within a range including 0 and not exceeding 0.05. While Cr is not essential, in synergy with Y and Al, it enhances the corrosion resisting effect of the hydrogen storage alloy and improves its durability.

However, when the amount of Cr exceeds 0.05 as the value f, cracking of the hydrogen storage alloy accompanying hydrogen storage and desorption is intensified, and consequently the durability of the alkaline storage battery decreases and the charge-discharge cycle life characteristics of the alkaline storage battery become inadequate. The value f is preferably 0.04 or less and more preferably 0.003 or more.

In the case where the hydrogen storage alloy according to the embodiment is a powder composed of small-diameter alloy particles, the content of Cr included in the alloy on a smaller side in the range of the embodiment suffices. Therefore, the content of Cr included in the hydrogen storage alloy can be reduced, and the discharge capacity of the alkaline storage battery can be increased accordingly.

Fe: Fe_{g} (where 0≤g≤0.35)

Fe is contained as the component B of the hydrogen storage alloy of which the main phase is one selected from or both of the A₂B₇-type crystal structure and the A₅B₁₉-type crystal structure. That is, Fe may be contained as an essential element of the hydrogen storage alloy according to the present invention. Fe is effective in controlling the hydrogen equilibrium pressure relevant to the battery voltage of the alkaline storage battery and can significantly improve the corrosion resistance, and thus has an effect of improving the durability of the hydrogen storage alloy, i.e., an effect on the charge-discharge cycle life characteristics of the alkaline storage battery.

By having Fe and Y as essential elements among the constituent elements of the hydrogen storage alloy according to the present invention, the hydrogen equilibrium pressure can be easily controlled to a pressure appropriate for an alkaline storage battery, and high corrosion resistance, high durability, and a low price can be realized.

To reliably exert these effects, the value g representing the atomic ratio of Fe in General Formula (1) is within a range of 0 or more but 0.35 or less.

When the value g exceeds 0.35, the discharge capacity of the alkaline storage battery decreases. A preferable value g exceeds 0 but does not exceed 0.30. In the case of a nickel hydrogen battery, under positive electrode regulations on the battery capacity, the hydrogen storage alloy used for the negative electrode is used in an amount 20 to 30% more than normal, which is called a reservoir, on the assumption of alkaline corrosion of the hydrogen storage alloy due to an alkaline solution that is an electrolytic solution.

On the other hand, adopting the hydrogen storage alloy according to the embodiment that includes Fe as an essential element for an alkaline storage battery can maximally mitigate the capacity degradation of the discharge capacity of the battery. That is, in the alkaline storage battery including the hydrogen storage alloy according to the embodiment, since the discharge capacity degrades less, the amount of hydrogen storage alloy in the part corresponding to the reservoir where an extra amount of the alloy is used on the assumption of alkaline corrosion can be substantially reduced.

That is, in the hydrogen storage alloy according to the embodiment, when Fe is used as an essential element by substituting part of expensive Ni in the component composition with inexpensive Fe, not only the material cost required to manufacture the hydrogen storage alloy but also the amount to be used of the hydrogen storage alloy that is included in the alkaline storage battery can be maximally reduced. As a result, by adopting the hydrogen storage alloy according to the embodiment that includes inexpensive and easily available Fe as an essential element for an alkaline storage battery, a cost reduction of the manufacturing cost of the alkaline storage battery can be realized.

Ratio Between Component A and Component B: 3.20≤d+e+f+g≤3.75 (Preferably 3.25≤d+e+f+g≤3.70)

The stoichiometric ratio that is the molar ratio of the component B (Ni, Al, and Cr) to the component A of the A₂B₇-type structure, the A₅B₁₉-type structure, and the AB₃-type structure, i.e., the value of d+e+f+g represented in the general formula is within a range of 3.20 or more but 3.75 or less.

When the value of d+e+f+g is less than 3.20, a sub-phase, i.e., an AB₂ phase increases in the hydrogen storage alloy, and particularly the discharge capacity of the alkaline storage battery decreases.

The AB₂ phase formed within the range of the composition of the hydrogen storage alloy according to the embodiment has such properties that hydrogen is stored but is not easily desorbed. Consequently, the hydrogen storage capacity of the hydrogen storage alloy decreases and the discharge capacity of the alkaline storage battery decreases.

On the other hand, when the value of d+e+f+g exceeds 3.75, the AB₅ phase increases in the hydrogen storage alloy, and pulverization of alloy powder of the hydrogen storage alloy accompanying hydrogen storage and desorption intensifies. As a result, the durability of the hydrogen storage alloy, i.e., the cycle life of the alkaline storage battery decreases. The value of d+e+f+g is preferably within a range of 3.25 or more but 3.70 or less.

It is preferable that the hydrogen storage alloy according to the embodiment have the above-described composition, and that a mass-based 50% undersize fraction particle diameter D50 of alloy particles pulverized from this hydrogen storage alloy be within a range of 3 μm or more but 30 μm or less, and that a mass-based 90% undersize fraction particle diameter D90 thereof be within a range of 8 μm or more but 60 μm or less.

When the mean particle diameter of the alloy particles pulverized from the hydrogen storage alloy according to the embodiment is set to be within the predetermined range, the hydrogen storage alloy has excellent hydrogen storage-desorption characteristics as well as durability.

### [Hydrogen Storage-Desorption Characteristics of Hydrogen Storage Alloy]

It is preferable that a hydrogen storage capacity H/M (H is the number of atoms of hydrogen, M is the number of atoms of metal) of the hydrogen storage alloy of the embodiment when a hydrogen pressure is applied up to 1 MPa at 80° C. be 0.94 or more.

Further, it is preferable that a hydrogen pressure when the hydrogen storage capacity (H/M: the ratio between the numbers of atoms of hydrogen atoms (H) and metal atoms (M)) during hydrogen desorption at 80° C. is 0.5 (P0.5, hereinafter called “hydrogen equilibrium pressure”) be 0.025 MPa or more but 0.12 MPa or less.

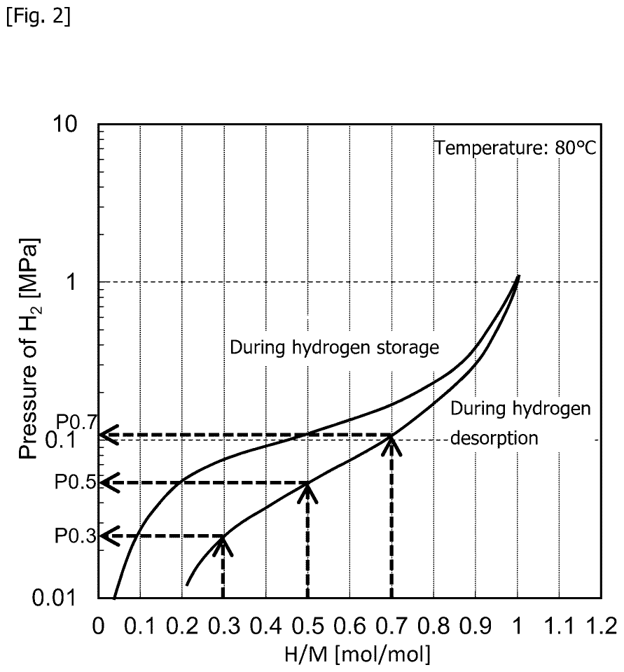

When the hydrogen storage capacity is within this range, the battery can operate under various temperature conditions without problems. FIG. 2 shows a specific example of pressure-composition-temperature (PCT) characteristics that measure the hydrogen equilibrium pressure and the hydrogen storage capacity.

In improving the characteristics of a nickel hydrogen battery, the discharge capacity is largely determined by the component composition of the hydrogen storage alloy. On the other hand, the durability of the hydrogen storage alloy is affected by the degree of pulverization of the hydrogen storage alloy accompanying hydrogen storage and desorption, elution of components of the hydrogen storage alloy into an aqueous alkaline solution, etc. This depends on the component composition of the hydrogen storage alloy, the ratio of an alloy phase formed based on a heat treatment, and the properties of the alloy phase.

From these technical viewpoints, in pursuing the development of a hydrogen storage alloy that meets the requirement of high durability, studies involving evaluation of the crackability of a hydrogen storage alloy due to repeated hydrogen storage and desorption were vigorously conducted.

As a result, to evaluate the crackability of a hydrogen storage alloy, alloy particles that had been mechanically ground from the hydrogen storage alloy and sieved to 150 μm or more but 1 mm or less were used. Hydrogen was pressurized up to 3 MPa at 80° C. to make the alloy store the hydrogen, and then evacuation was performed to make the alloy desorb the hydrogen.

A particle size distribution of the alloy particles after this cycle had been repeated five times was evaluated, and a volume mean particle diameter (MV) was presented as a representative value. Thus, a hydrogen storage alloy with particularly excellent durability was found out. Detailed conditions are as follows. Here, “sieved to 150 μm or more but 1 mm or less” means being above a sieve with 150 μm openings and below a sieve with 1 mm openings.

Specifically, 7 g of the hydrogen storage alloy is charged into a measurement holder of a PCT evaluation device and evacuation (0.01 MPa or less) is performed at 80° C. for one hour. Thereafter, while the temperature is maintained, a hydrogen storage-desorption measurement (PCT characteristics evaluation) is performed within a range of the hydrogen pressure of 0.01 to 3 MPa.

Thereafter, evacuation (0.01 MPa) is performed for one hour, and a hydrogen gas is introduced up to 3 MPa and held for one hour to make the hydrogen storage alloy store the hydrogen almost to the upper limit, and evacuation (0.01 MPa) is performed for one hour to make the hydrogen storage alloy desorb the hydrogen. This cycle is repeated three times.

Finally, as in the first cycle, a hydrogen storage-desorption measurement (PCT characteristics evaluation) is performed within a range of the hydrogen pressure of 0.01 to 3 MPa. The difference between the hydrogen storage and desorption in the first and fifth cycles and the hydrogen storage and desorption in the second to fourth cycles is the process time. In the hydrogen storage and desorption in the second to fourth cycles, the hydrogen pressure is applied up to 3 MPa at once, and therefore the required time is shorter.

After the hydrogen storage-desorption cycle is thus performed five times in total, the hydrogen storage alloy powder is taken out and a particle size distribution measurement is performed. It is preferable that the range of the volume mean particle diameter MV of the alloy particles pulverized from the hydrogen storage alloy after repeated hydrogen storage and desorption be 75 μm or more. The volume mean particle diameter MV of the alloy particles within this range is preferable because pulverization of the hydrogen storage alloy accompanying charge and discharge when the hydrogen storage alloy is actually incorporated into an alkaline storage battery does not progress. Thus, it can be seen that the hydrogen storage alloy according to the embodiment has excellent durability coupled with its favorable corrosion resistance in an aqueous alkaline solution.

The volume mean particle diameter MV of the alloy particles can be measured by a laser-diffraction particle size distribution measurement device, and as the measurement device, for example, MT3300EXII manufactured by MicrotracBEL Corp. can be used.

Cracking of the hydrogen storage alloy is considered to be attributable to distortion of the crystal lattice of the alloy due to expansion and contraction accompanying hydrogen storage and desorption. Therefore, when the hydrogen storage capacity is low, the expansion and contraction of the crystal lattice become small and consequently the hydrogen storage alloy is less likely to pulverize.

On the other hand, a low hydrogen storage capacity of the hydrogen storage alloy is not preferable, because the discharge capacity as a battery material becomes low and obtaining a certain battery capacity leads to an increase in size and cost of the battery.

Therefore, as a condition required to realize the volume mean particle diameter MV of the alloy particles pulverized from the hydrogen storage alloy after repeated hydrogen storage and desorption as described above, it is preferable that the value of the index H/M (the atomic ratio between hydrogen H and metal M) of the hydrogen storage capacity at 1 MPa obtained from a PCT measurement at 80° C. be set to 0.94 or more. When the hydrogen storage capacity is within this range, the alkaline storage battery having a negative electrode including such a hydrogen storage alloy as a negative-electrode active material can retain a sufficient discharge capacity, and therefore it can be said that a high-durability hydrogen storage alloy has been obtained.

As shown in FIG. 2, a plateau slope B during hydrogen desorption after storage expressed by Relational Expression (A) below was calculated based on a hydrogen pressure P0.3 (MPa) when the hydrogen storage capacity H/M=0.3 and a hydrogen pressure P0.7 (MPa) when the hydrogen storage capacity H/M=0.7. That is, the plateau slope B is a value calculated by the aforementioned Relational Expression (A) by measuring hydrogen pressures when the hydrogen storage capacity H/M=0.7 and the hydrogen storage capacity H/M=0.3 on a hydrogen desorption curve.

$$\begin{matrix}[ Mathematical Formula 2 ] & \\ Plateau slope B = [ log ( P 0.7 / P 0.3 ) ] / 0.4 & ( A )\end{matrix}$$

That is, it is preferable that the plateau slope B that is a value calculated by [log(P0.7/P0.3)]/0.4 expressed by the above Relational Expression (A) be within a range of 1.3 or more but 3.0 or less. When the plateau slope B is less than 1.3, expansion of the crystal lattice of the hydrogen storage alloy during hydrogen storage is likely to occur in one direction, in other words, the crystal lattice is likely to stretch and shrink anisotropically. Thus, due to strain caused in the crystal lattice of the hydrogen storage alloy, cracking of the hydrogen storage alloy may intensify.

On the other hand, when the plateau slope B exceeds 3.0, even when a hydrogen pressure is applied, the hydrogen storage capacity is less likely to increase, which may result in reduced discharge capacity of the alkaline storage battery. The value of the plateau slope B is preferably 1.35 or more but 2.95 or less.

### [X-Ray Diffraction Intensity Ratio]

In the hydrogen storage alloy of the embodiment, it is preferable that, in an X-ray diffraction measurement using Cu-Kα radiation as an X-ray source, ζ/ε≤0.08 holds true, where ζ/ε is a ratio of diffraction intensity (ζ) of (101) plane of the AB₅ phase to diffraction intensity (ε) of a strongest diffraction peak present in a range of a diffraction angle of 40 to 45°. When the ratio ζ/ε exceeds 0.08, the charge-discharge cycle life characteristics of the alkaline storage battery may degrade. The ratio ζ/ε is more preferably 0.05 or less.

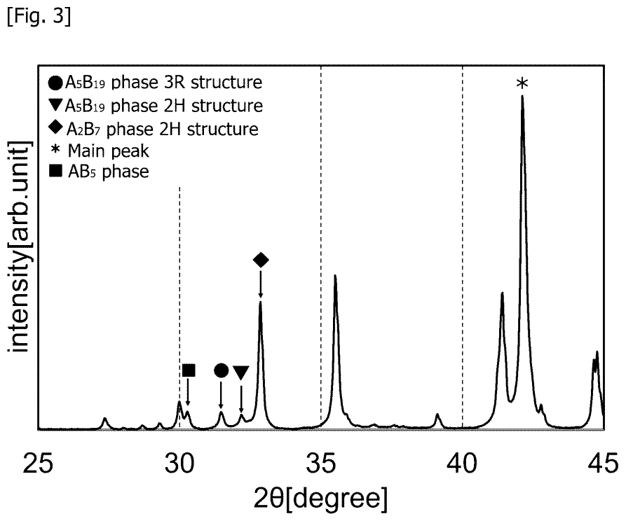

FIG. 3 is a graph showing one example of an X-ray diffraction measurement result relating to the hydrogen storage alloy according to the embodiment. A diffraction line is specifically described based on the XRD graph of FIG. 3. The ratio ζ/ε is a ratio of the height of the diffraction peak indicated by the black square to the height of the strongest diffraction peak indicated by the asterisk. When the ratio ζ/ε is within this range, the ratio of the AB₅ phase that reduces the durability of the hydrogen storage alloy is low, so that improvement in the durability of the hydrogen storage alloy can be expected.

The X-ray diffraction measurement conditions are as follows. A powder of the hydrogen storage alloy composed of alloy particles having been ground to below a particle diameter of 75 μm is set in a sample holder, and the measurement is performed, with Cu as the target and using only a ko filter, under the following conditions:
Tube voltage: 40 kV
Tube current: 40 mA
Scanning speed: 0.5°/min
Scanning step: 0.020
Divergence slit (DS): 1°
Scattering slit (SS): 1°
Receiving slit (RS): none

### [Alloy Surface Layer]

On the surface of the hydrogen storage alloy of the present invention, a surface layer formed by an oxide layer or a hydroxide layer including an appropriate amount of Y indicated in General Formula (1) is formed in close contact with the alloy particles composing the hydrogen storage alloy. Thus, owing to the presence of the surface layer formed by an oxide layer or a hydroxide layer including an appropriate amount of Y, the hydrogen storage alloy of the present invention has excellent durability.

This surface layer is formed as an element, such as Y, included inside the hydrogen storage alloy beforehand turns into a metal oxide or a metal hydroxide in the course of production of a negative-electrode active material and becomes included as an oxide layer or a hydroxide layer on the surface of the hydrogen storage alloy. It is preferable that the surface layer formed by an oxide layer or a hydroxide layer including Y be “composed mainly of a rare earth element” included in the hydrogen storage alloy and include Mg and Al. Here, “composed mainly of a rare earth element” means that an oxide or a hydroxide of a rare earth element accounts, in mass ratio, for more than half of the oxide layer or the hydroxide layer formed on the surface of the hydrogen storage alloy.

A BET specific surface area of the hydrogen storage alloy is preferably more than 0.5 m²/g, more preferably 0.55 to 7.0 m²/g, and even more preferably 0.6 to 4.0 m²/g. When the BET specific surface area is within this range, the hydrogen storage alloy is suitably used as a negative-electrode active material included in a negative electrode of an alkaline storage battery. It is preferable that the hydrogen storage alloy in which the surface layer is present have a pore volume of 0.013 cm³/g or less and a mean pore diameter of 40 nm or less. More preferably, the pore volume is within a range of 0.0025 to 0.0125 cm³/g and the mean pore diameter is within a range of 10 to 35 nm. When the pore volume exceeds 0.013 cm³/g and the mean pore diameter exceeds 40 nm and thus both are too large, the density of the surface layer becomes lower and the probability of occurrence of cracks increases, which may lead to reduced durability of the hydrogen storage alloy.

On the other hand, when the pore volume is less than 0.0025 cm³/g and the mean pore diameter is less than 10 nm and thus both are small, impregnation of the surface layer of the hydrogen storage alloy with an electrolytic solution becomes insufficient and the hydrogen storage-desorption characteristics degrade. The thickness of the surface layer formed by an oxide layer or a hydroxide layer that is in close contact with the alloy particles is 500 nm or smaller and preferably within a range of 50 to 450 nm. When the thickness of the surface layer exceeds 500 nm and is too large, impregnation of the surface layer of the hydrogen storage alloy with an electrolytic solution becomes insufficient, which may lead to degradation of the hydrogen storage-desorption characteristics. On the other hand, when a surface layer is not formed on the surface of the hydrogen storage alloy of the present invention, the corrosion resistance of the hydrogen storage alloy decreases considerably.

In the hydrogen storage alloy according to the embodiment, to achieve compatibility between high output and high durability, the durability of the alloy itself, i.e., pulverization of the alloy accompanying hydrogen storage and desorption is mitigated. Further, in such a hydrogen storage alloy, a surface layer excellent in both hydrogen storage-desorption characteristics and alkaline corrosion resistance is easy to form on the surface of the alloy particles. Thus, the hydrogen storage alloy according to the embodiment is particularly excellent in durability. That is, an alkaline storage battery using this hydrogen storage alloy as a negative-electrode active material realizes high output characteristics while being excellent in charge-discharge cycle characteristics.

### [Manufacturing Method of Hydrogen Storage Alloy]

Next, a manufacturing method of the hydrogen storage alloy of the embodiment will be described.

For the hydrogen storage alloy of the embodiment, metal elements including rare earth elements (Sm, Y, La, Ce, etc.), magnesium (Mg), nickel (Ni), aluminum (Al), chromium (Cr), and iron (Fe) are weighed to a predetermined molar ratio. Thereafter, these raw materials are fed into an alumina crucible installed in a high-frequency induction furnace and melted in an atmosphere of an inert gas, such as an argon gas, and are then cast into a casting mold to produce an ingot of the hydrogen storage alloy. Alternatively, the hydrogen storage alloy according to the embodiment may be directly produced as a sample in a form of flakes with a thickness of about 200 to 500 μm by using a strip casting method.

Since the hydrogen storage alloy of the embodiment contains Mg that has a low melting point and a high vapor pressure as a main component, if the raw materials of all the alloy components are melted at once, Mg may evaporate and it may become difficult to obtain an alloy of the target chemical composition. Therefore, in manufacturing the hydrogen storage alloy of the embodiment by a melting method, it is preferable that first the alloy components other than Mg be melted and that then Mg raw materials such as metal Mg and Mg alloy be fed into the resulting molten metal. It is desirable that this melting step be performed in an atmosphere of an inert gas, such as argon or helium. Specifically, it is preferable that this step be performed in a depressurized atmosphere created by adjusting an inert gas containing 80 vol % or more argon gas to 0.05 to 0.2 MPa. It is preferable that the alloy melted under these conditions be thereafter cast into a water-cooled casting mold and solidified into an ingot of the hydrogen storage alloy.

Next, using a differential scanning calorimeter (DSC), the melting point (Tₘ) of the obtained ingot of the hydrogen storage alloy is measured. This is because it is preferable that the hydrogen storage alloy of the embodiment be subjected to a heat treatment of holding the ingot cast as described above at an appropriate temperature that is 800° C. or higher but the melting point (Tₘ) of the alloy or lower, in an atmosphere of either an inert gas, such as argon or helium, or a nitrogen gas, or an atmosphere of a mixture of these gases, for three to 50 hours.

By this heat treatment, the total ratio of the A₂B₇-type, A₅B₁₉-type, and AB₃-type crystal structures as the main phase in the hydrogen storage alloy can be set to 70 mass % or more, and preferably the total ratio of the A₂B₇-type and A₅B₁₉-type crystal structures can be set to 70 mass % or more, while the AB₂ phase and the AB₅ phase that are sub-phases generated during casting can be reduced or eliminated.

That the crystal structure of the main phase of the obtained hydrogen storage alloy is the A₂B₇-type structure, the A₅B₁₉-type structure, and the AB₃-type structure can be confirmed by an X-ray diffraction measurement using Cu-Kα radiation. The main phase of the hydrogen storage alloy means exceeding 50 mass % and is preferably 70 mass % or more.

When the heat treatment temperature is lower than 800° C., diffusion of the elements is insufficient, so that sub-phases remain, which may cause a decrease in the discharge capacity or degradation of the charge-discharge cycle characteristics of the battery. On the other hand, when the heat treatment temperature is not lower than the melting point Tₘ minus 20° C. (not lower than Tₘ−20° C.) of the alloy, coarsening or partial melting of crystal particles of the main phase or evaporation of the Mg component occurs, which may result in a decrease in the hydrogen storage capacity due to pulverization or a change in the chemical composition. Therefore, the heat treatment temperature is preferably within a range of 800° C. to (Tₘ−30° C.).

When the holding time of the heat treatment is three hours or shorter, the ratio of the main phase cannot be stably set to 70 mass % or more, and the homogenization of the chemical components of the main phase becomes insufficient. Thus, expansion and contraction of the crystal lattice forming the hydrogen storage alloy during hydrogen storage and desorption become non-uniform, and the amounts of the resulting distortion and defects increase, which may adversely affect the charge-discharge cycle life characteristics of the alkaline storage battery as well.

The holding time of the heat treatment is preferably four hours or longer, and more preferably five hours or longer from the viewpoint of homogenizing the main phase of the hydrogen storage alloy and improving the crystallizability thereof.

However, when the holding time exceeds 50 hours, the amount of evaporation of Mg becomes large and the chemical composition of the hydrogen storage alloy changes, which may result in formation of the AB₅-type sub-phase. Further, such a time is not preferable as it increases the manufacturing cost and may cause a dust explosion due to evaporated Mg fine powder.

The heat-treated hydrogen storage alloy is pulverized by a dry method or a wet method. When pulverizing the alloy by a dry method, the alloy is ground using, for example, a hammer mill or an ACM pulverizer, or the like. On the other hand, when pulverizing the hydrogen storage alloy by a wet method, the alloy is ground using a ball mill, an attritor, or the like. In particular, when obtaining fine powder of the hydrogen storage alloy, wet grinding is preferable as it can produce fine powder more safely.

When using the hydrogen storage alloy according to the embodiment for a battery for on-board applications, in terms of the balance among the battery characteristics including the output and the cycle life characteristics, the particle diameter of the alloy particles pulverized from the alloy is preferably within a range of 3 μm or more but 30 μm or less, and more preferably within a range of 5 μm or more but 25 μm or less, as a mass-based 50% undersize fraction particle diameter D50. Further, when the particle diameter distribution of the alloy particles is too wide, these characteristics degrade; therefore, it is preferable that a mass-based 10% undersize fraction particle diameter D10 be within a range of 0.5 μm or more but 15 μm or less, and that a mass-based 90% undersize fraction particle diameter D90 be within a range of 8 μm or more but 60 μm or less. In addition, it is more preferable that the 10% undersize fraction particle diameter D10 be within a range of 1 μm or more but 10 μm or less, and that the 90% undersize fraction particle diameter D90 be within a range of 10 μm or more but 50 μm or less.

The particle diameter of the alloy particles can be controlled by adjusting the conditions, such as the diameter and the amount of media and the rotation speed.

Here, as the above-described particle diameter distributions D50, D10, and D90 of the alloy particles, values measured by a laser diffraction-scattering particle size distribution measurement device are used. As the measurement device, for example, MT3300EXII manufactured by MicrotracBEL Corp. can be used.

The above-described hydrogen storage alloy according to the embodiment is an alloy of which the main phase is formed by the A₂B₇-type crystal structure, the A₅B₁₉-type crystal structure, and the AB₃-type crystal structure. Specifically, in the A₂B₇-type crystal structure, a Ce₂Ni₇ phase that is hexagonal (2H) and a Gd₂Co₇ phase that is rhombohedral (3R) can coexist without problems, and either phase exists, while including a larger amount of the former is preferable.

In the A₅B₁₉-type crystal structure (a Gd₅Co₁₉ phase that is hexagonal or a Pr₅Co₁₉ phase that is rhombohedral), including a larger amount of the former is preferable. It is preferable that the A₂B₇-type crystal structure, the A₅B₁₉-type crystal structure, and the AB₃-type crystal structure combined account for at least 70 mass % or more.

It is more preferable that the phases of the A₂B₇-type crystal structure and the A₅B₁₉-type crystal structure combined account for 70 mass % or more. These crystal structures of the hydrogen storage alloy can be evaluated by Rietveld analysis based on a result of an X-ray diffraction measurement.

To obtain a hydrogen storage alloy to be used as a negative-electrode active material of the embodiment in which a layer of an oxide or a hydroxide including Y is in close contact with the surface of the hydrogen storage alloy, the surface of the hydrogen storage alloy should be positively oxidized.

In the following, using the hydrogen storage alloy of the embodiment as an example, description will be given of a procedure of manufacturing the hydrogen storage alloy according to the embodiment that is used as a negative-electrode active material of an alkaline storage battery by performing treatment on the hydrogen storage alloy by a suitable method (hereinafter referred to as a hydrogen storage alloy treatment method).

The hydrogen storage alloy treatment method has:
N-1) a step of treating the hydrogen storage alloy with an aqueous alkaline solution; and
N-2) a step of oxidizing the surface of the hydrogen storage alloy having undergone step N-1).

While N-1) a step of treating the hydrogen storage alloy with an aqueous alkaline solution (hereinafter referred to simply as “step N-1)”) is not an essential step for oxidizing the hydrogen storage alloy, as will be described later, by going through this step, a more suitable hydrogen storage alloy according to the embodiment that can be used as a negative-electrode active material can be obtained.

First, “step N-1)” will be described.

The hydrogen storage alloy used for step N-1) is a hydrogen storage alloy of which the main phase is a phase formed by the A₂B₇-type crystal structure, the A₅B₁₉-type crystal structure, and the AB₃-type crystal structure containing rare earth elements, such as La, Y, and Ce, Mg, Al, and Ni.

When the hydrogen storage alloy is treated in step N-1) with an aqueous alkaline solution in which a hydroxide of alkali metal has been dissolved, corrosion progresses from the surface of the alloy.

In particular, among the components included in the hydrogen storage alloy, the rare earth elements, Mg, and Al that are prone to oxidization and have high dissolvability relative to an aqueous alkaline solution partially turn into an oxide or a hydroxide in their positions and are partially eluted from the surface of the hydrogen storage alloy.

Here, Ni has high corrosion resistance and low dissolvability relative to an aqueous alkaline solution, and therefore remains in its position. As a result, a layer in which metal, an oxide, and a hydroxide are mixedly present is formed on the surface of the hydrogen storage alloy.

Hereinafter, in the hydrogen storage alloy according to the embodiment, this surface layer newly formed on the surface of the hydrogen storage alloy will be referred to as a surface-treated layer. The surface-treated layer is composed of a metal oxide or a hydroxide of alkali metal. It is presumed that the performance of the hydrogen storage alloy used as a negative-electrode active material of an alkaline storage battery improves owing to the presence of this surface-treated layer formed on the surface of the hydrogen storage alloy.

As the hydroxide of alkali metal, lithium hydroxide, sodium hydroxide, and potassium hydroxide can be named as examples, and among these, sodium hydroxide is preferable. In some cases, using an aqueous sodium hydroxide solution as the aqueous alkaline solution leads to more favorable battery characteristics of the nickel hydrogen battery that is the alkaline storage battery according to the embodiment, compared with using other lithium hydroxide and potassium hydroxide.

As the aqueous alkaline solution, a strongly basic one is preferable. As the concentration of the hydroxide of alkali metal in the aqueous alkaline solution, preferably a range of 10 to 60 mass % and more preferably a range of 20 to 55 mass % can be given as examples.

It is preferable that step N-1) be performed by a method of immersing the hydrogen storage alloy in the aqueous alkaline solution. In that case, it is preferable that this step be performed under a stirring condition and be performed under a heating condition. As the range of the heating temperature, preferably a range of 50 to 150° C. and more preferably a range of 70 to 140° C. can be given as examples. While the heating time can be determined as appropriate according to the concentration of the aqueous alkaline solution, the heating temperature, and the stirring condition, preferably a range of 0.1 to ten hours and more preferably a range of 0.2 to five hours can be given as examples.

The relationship between the hydrogen storage alloy and the amount of aqueous alkaline solution is preferably within a range of 1:0.5 to 1:10, and more preferably within a range of 1:0.7 to 1:8, in mass ratio. When the amount of aqueous alkaline solution is too small, the surface-treated layer may fail to be sufficiently formed on the hydrogen storage alloy, whereas too large an amount of aqueous alkaline solution is disadvantageous in terms of costs.

In the aqueous alkaline solution at the point of completion of step N-1), the rare earth elements, Mg, and Al that have been partially eluted from the hydrogen storage alloy are present. During separation of the aqueous alkaline solution and the hydrogen storage alloy, these rare earth elements, Mg, and Al can adhere to the surface of the hydrogen storage alloy as hydroxides of the rare earth elements, Mg, and Al.

In step N-1), subsequently to the treatment with the aqueous alkaline solution, washing of the hydrogen storage alloy with water may be performed. Performing water washing can remove any aqueous alkaline solution adhering to the surface of the hydrogen storage alloy. The relationship between the amounts of the hydrogen storage alloy and the water during water washing is preferably 1:1 to 1:50, and more preferably 1:2 to 1:30, in mass ratio.

Next, N-2) a step of oxidizing the surface of the hydrogen storage alloy having undergone step N-1) (hereinafter referred to simply as “step N-2)”) will be described.

Water washing of the hydrogen storage alloy that can be performed after the treatment with the aqueous alkaline solution in step N-1) described above may be performed in ambient air as step N-2). For step N-2), a method of oxidizing the surface of the hydrogen storage alloy with oxygen in the air by exposing the hydrogen storage alloy to the air may be adopted, or a method of oxidizing the hydrogen storage alloy by bringing it into contact with an oxidant, such as hydrogen peroxide, may be adopted.

It is preferable that either method be implemented while the hydrogen storage alloy is cooled to mitigate excessive heating up of the hydrogen storage alloy. Specifically, it is preferable that the method be implemented while the hydrogen storage alloy is splashed with water to cool the hydrogen storage alloy, or that the method be implemented after the hydrogen storage alloy is disposed in water or after the hydrogen storage alloy is disposed in an aqueous solution including an oxidant, such as hydrogen peroxide.

A preferable negative-electrode active material of the embodiment that is manufactured by going through steps N-1) and N-2) contains, on its surface, a layer in which metal, an oxide, and a hydroxide are mixedly present. A preferable negative-electrode active material of the embodiment can be expressed as being provided on its surface with the surface-treated layer in which metal, an oxide, and a hydroxide are mixedly present.

By going through the above-described process, a surface layer formed by an oxide layer or a hydroxide layer containing at least partially Y can be formed on and in close contact with the surface of the hydrogen storage alloy of the embodiment. Thus, the corrosion resistance of the hydrogen storage alloy of the embodiment improves.

It is preferable that the oxide or the hydroxide included in the surface-treated layer of the hydrogen storage alloy be composed mainly of rare earth elements, Mg, and Al that are included in the hydrogen storage alloy.

Further, it is preferable that the hydrogen storage alloy in which the surface-treated layer formed by an oxide layer or a hydroxide layer is formed have a pore volume of 0.013 cm³/g or less and a mean pore diameter of 40 nm or less. When the pore volume exceeds 0.013 cm³/g, the density of the surface-treated layer becomes lower and the probability of occurrence of cracks increases, so that corrosion of the hydrogen storage alloy due to immersion in the aqueous alkaline solution may accelerate, i.e., the corrosion resistance of the alloy may decrease. When the mean pore diameter exceeds 40 nm and is too large, immersion in the aqueous alkaline solution becomes excessive, so that corrosion of the hydrogen storage alloy may accelerate, i.e., the durability may degrade.

On the other hand, when the pore volume is less than 0.0025 cm³/g and the mean pore diameter is less than 10 nm, impregnation of the hydrogen storage alloy with an electrolytic solution becomes insufficient, so that the hydrogen storage-desorption characteristics of the alloy may degrade. Preferably, the pore volume is 0.0025 to 0.0125 cm³/g and the mean pore diameter is 10 to 35 nm.

Further, it is preferable that the surface layer formed by an oxide layer or a hydroxide layer containing at least partially Y that is formed on the surface of the hydrogen storage alloy according to the embodiment have a thickness of 500 nm or smaller where it is in close contact with the surfaces of the alloy particles. When the thickness of the surface layer exceeds 500 nm, impregnation of the hydrogen storage alloy with an electrolytic solution becomes insufficient, so that the hydrogen storage-desorption characteristics of the alloy may degrade.

On the other hand, when the surface-treated layer is not formed even on at least part of the hydrogen storage alloy according to the embodiment, the corrosion resistance of the alloy decreases significantly. The thickness of the surface layer is preferably 50 to 450 nm.

An analysis of the surface of the negative-electrode active material is as follows. The surface-treated layer formed on the surface of the hydrogen storage alloy was observed using a transmission electron microscope. Specifically, after negative-electrode active material powder was mixed into epoxy resin, the resin was cured at 120° C. for 30 minutes to embed the powder in the resin.

Thereafter, a sample in a form of flakes of 100 nm or less is obtained by a flaking process using an argon beam. For the flaking process, an ion slicer (EM-09100IS) manufactured by JEOL Ltd. is used. The alloy is thinly ground at an acceleration voltage of 6 kV until pores of a few μm open, and then finishing is performed at an acceleration voltage of 1.0 kV for 15 minutes. For the obtained flaky sample, the surface-treated layer obtained on the alloy surface is observed using a transmission electron microscope (JEM-2100F manufactured by JEOL Ltd.) at an acceleration voltage of 200 kV. In addition, using an energy dispersive X-ray emission spectrometer (JED-2300 manufactured by JEOL Ltd.) installed in that device, an analysis of elements included in the surface-treated layer is performed.

An analysis of the pore diameter distribution involves evaluation by the following technique. After the negative-electrode active material is vacuum-dried at 100° C. for two hours, a nitrogen adsorption-desorption isothermal line at a liquid nitrogen temperature (77.3 K) of the negative-electrode active material is measured using a fully automatic gas adsorption measuring device (AS1-MP, Anton Paar GmbH).

A nitrogen adsorption amount per unit weight of the hydrogen storage alloy on the adsorption-desorption isothermal line is calculated so as to be represented by a volume of gaseous nitrogen in a standard state (STP; Standard Temperature and Pressure).

Here, the standard state of the gas is assumed to be 0° C. and 101325 Pa, with symbol “N” attached before the unit of volume. The total pore volume was calculated from the following Calculation Formula (B), with the nitrogen adsorption amount at a relative pressure (p/p0=0.99) on the storage isothermal line being V [Ncm³/g]:

$$\begin{matrix}[ Mathematical Formula 3 ] & \\ Total pore volume ( {cm}^{3} / g ) = V / 22414 \times ( M / ρ ) & ( B )\end{matrix}$$

In this Formula, the volume of 1 mol of the gas in the standard state is 22414 Ncm³; the molecular weight M of the nitrogen is 28.013 g/mol; and the density p of the nitrogen in a liquid phase state is 0.808 g/cm³.

Further, using the adsorption-desorption isothermal line, the pore diameter distribution in a mesopore region is analyzed by the BJH method, and the pore diameter distribution in a micropore-mesopore region is analyzed by the DFT method, and the mean pore diameter is calculated.

It is preferable that the BET specific surface area of the hydrogen storage alloy that is used as a negative-electrode active material according to the embodiment be more than 0.5 m²/g. When the BET specific surface area of the hydrogen storage alloy is not more than that, the mean pore diameter may become too large. The BET specific surface area of the hydrogen storage alloy is more preferably within a range of 0.55 to 7.0 m²/g and even more preferably within a range of 0.6 to 4.0 m²/g.

Other than the aqueous alkaline solution treatment of step N-1) and the surface oxidation step of step N-2), an acidic treatment step may be combined with these steps.

In the acidic treatment step, an acidic treatment of the surface of the hydrogen storage alloy is performed using an aqueous solution of nitric acid, sulfuric acid, hydrochloric acid, or the like. By the acidic treatment step, a hydrogen storage alloy that exhibits more favorable battery characteristics, particularly durability and low-temperature discharge characteristics, can be obtained. This is because, as a large number of Ni fine particles are precipitated on the surface of the hydrogen storage alloy, the catalytic action of the hydrogen storage alloy improves and hydrogen storage-desorption is easily performed.

Therefore, the discharge characteristics at low temperatures improve, and the corrosion resistance improves as Ni fine particles on the surface increase, resulting in improved durability.

### [Alkaline Storage Battery]

Next, an example of the configuration of the alkaline storage battery including a negative electrode that uses the hydrogen storage alloy of the present invention will be described with reference to FIG. 1.

Here, the alkaline storage battery 10 of the present invention is composed of at least the positive electrode 1, the negative electrode 2, and the separator 3, and the casing 4 (battery case) that is filled with an electrolyte and houses these components. A specific description follows.

### <Positive Electrode>

The positive electrode 1 is typically composed of a positive-electrode active material layer and a positive-electrode current collector. The positive-electrode active material layer contains at least a positive-electrode active material. The positive-electrode active material layer may further contain at least one of a positive electrode additive, a conduction aid, a binder, and a thickener.

The positive-electrode active material is not particularly limited as long as the material functions as a battery when combined with the above-described hydrogen storage alloy (negative electrode material), and examples include elemental metals, alloys, and hydroxides.

As the positive-electrode active material, a material that includes nickel oxide and is mainly composed of nickel oxyhydroxide and/or nickel hydroxide can be used. The amount of nickel oxide in the positive-electrode active material is, for example, 90 to 100 mass %, and may be 95 to 100 mass %. The mean particle diameter of the nickel oxide can be selected as appropriate from a range of 3 to 35 μm, for example, and is preferably within a range of 3 to 25 μm.

As the positive-electrode active material, a positive-electrode active material around which a layer of a conduction aid has been formed beforehand is preferable. Further, a positive-electrode active material around which a layer of cobalt oxyhydroxide has been formed and the layer of the cobalt oxyhydroxide has been doped with alkali metal beforehand is preferable.

The positive electrode additive is added to the positive electrode to improve the battery characteristics of the nickel hydrogen battery. The positive electrode additive is not limited as long as the additive is one that is used as a positive electrode additive for nickel-metal hydride batteries. Specific examples of positive electrode additives include niobium compounds such as Nb₂O, tungsten compounds such as WO₂, WO₃, Li₂WO₄, Na₂WO₄, and K₂WO₄, ytterbium compounds such as Yb₂O₃, titanium compounds such as TiO₂, yttrium compounds such as Y₂O₃, zinc compounds such as ZnO, calcium compounds such as CaO, Ca(OH)₂, and CaF₂, and other rare earth oxides.

The conduction aid is not particularly limited as long as the material can impart electron conductivity to the positive electrode, and examples include metal powders such as an Ni powder, oxides such as cobalt oxide, and carbon materials such as graphite and carbon nanotube. While the amount of conduction aid to be added is not particularly limited, for example, relative to 100 parts by mass of the positive-electrode active material, a range of 0.1 to 50 parts by mass is preferable, and a range of 0.1 to 30 parts by mass is more preferable.

The binder fulfills a role of anchoring an active material etc. to the surface of the current collector. The binder is not limited as long as the binder is one that is used as a binder for electrodes of nickel hydrogen batteries. Specific examples of binders include fluorine-containing resins such as polyvinylidene fluoride, polytetrafluoroethylene, and fluoro-rubber, polyolefin resins such as polypropylene and polyethylene, imide-based resins such as polyimide and polyamide imide, cellulose derivatives such as carboxymethylcellulose, methylcellulose, and hydroxypropylcellulose, copolymers such as styrene-butadiene rubber, and (meth)acrylic resins such as polyacrylic acid, polyacrylic acid ester, polymethacrylic acid, and polymethacrylic acid ester that contain a (meth)acrylic acid derivative as a monomer unit. Relative to 100 parts by mass of the positive-electrode active material, the amount of binder should be, for example, 7 parts by mass or less, and may be within a range of 0.01 to 5 parts by mass and further may be within a range of 0.05 to 2 parts by mass.

Further, examples of thickeners include carboxymethylcellulose and its modifications (including salt such as Na salt), cellulose derivatives such as methylcellulose, saponified polymers having a vinyl acetate unit such as polyvinyl alcohol, and polyalkylene oxide such as polyethylene oxide. One type of these thickeners may be used independently or two or more types thereof may be used in combination. Relative to 100 parts by mass of the positive-electrode active material, the amount of thickener is, for example, 5 parts by mass or less, and may be within a range of 0.01 to 3 parts by mass and further may be within a range of 0.05 to 1.5 parts by mass.

Examples of the material of the positive-electrode current collector include stainless steel, aluminum, nickel, iron, and titanium. Examples of the form of the positive-electrode current collector include a foil form, a mesh form, and a porous form, and any form may be adopted.

The positive electrode can be formed by attaching a positive-electrode composite material including a positive-electrode active material to a support body (positive-electrode current collector). The positive-electrode composite material is typically formed by turning the above-described positive-electrode active material, positive electrode additive, conduction aid, and binder all together into a paste. As a dispersion medium, water, an organic medium, a mixed medium that is a mixture of two or more types of media selected from them, etc. can be used. As necessary, a positive electrode additive, a conduction aid, a binder, a thickener, etc. may be added, but these (particularly the positive electrode additive, the binder, and the thickener) need not be necessarily added.

For the positive electrode, the aforementioned positive-electrode composite material paste may be applied to the support body, or may be packed into holes of the support body, according to the form of the support body etc. The positive electrode can be formed by applying or packing the positive-electrode composite material paste to or into the support body, drying the paste to remove the dispersion medium, and compressing the obtained dry product in a thickness direction (e.g., rolling it between a pair of rolls).

### <Negative Electrode>

The negative electrode 2 is typically composed of a negative-electrode active material layer and a negative-electrode current collector. The negative-electrode active material layer needs to contain at least the above-described hydrogen storage alloy of the present invention as a negative-electrode active material. The negative-electrode active material layer may further contain at least one of a negative electrode additive, a conduction aid, a binder, and a thickener.

The negative electrode additive is added to the negative electrode to improve the battery characteristics of the nickel-metal hydride battery. The negative electrode additive is not limited as long as the additive is one that is used as a negative electrode additive for nickel-metal hydride batteries. Specific examples of negative electrode additives include fluorides of rare earth elements such as CeF₃ and YF₃, bismuth compounds such as Bi₂O₃ and BiF₃, indium compounds such as In₂O₃ and InF₃, and compounds that have been named as examples of positive electrode additives.

The conduction aid is not particularly limited as long as the material can impart electron conductivity. Examples include metal powder such as Ni powder, oxides such as cobalt oxide, and carbon materials such as graphite and carbon nanotube. While the amount of conduction aid to be added is not particularly limited, for example, relative to 100 parts by mass of hydrogen storage alloy powder, the amount is preferably within a range of 0.1 to 50 parts by mass and more preferably within a range of 0.1 to 30 parts by mass.

Examples of binders include synthetic rubber such as styrene-butadiene rubber (SBR), cellulose such as carboxymethylcellulose (CMC), polyol such as polyvinyl alcohol (PVA), and fluorine resins such as polyvinylidene fluoride (PVDF). Relative to 100 parts by mass of hydrogen storage alloy powder, the amount of binder should be, for example, 7 parts by mass or less, and may be within a range of 0.01 to 5 parts by mass and further may be within a range of 0.05 to 2 parts by mass.

Examples of the material of the negative-electrode current collector include steel, stainless steel, aluminum, nickel, iron, titanium, and carbon. Examples of the form of the negative-electrode current collector include a foil form, a mesh form, and a porous form, and any form may be adopted.

To form a negative-electrode active material layer on the negative-electrode current collector, components included in the negative-electrode active material layer including the negative-electrode active material are turned into a paste, which is a negative electrode paste. The negative electrode paste is produced by adding the above-described negative-electrode active material, negative electrode additive, conduction aid, binder, thickener, etc. into a solvent.

This negative electrode for a nickel-metal hydride battery is produced by forming the negative electrode paste including the hydrogen storage alloy powder of the present invention as the negative-electrode active material into a predetermined shape, and supporting the formed negative electrode paste by a negative electrode core material (negative-electrode current collector), or is produced by preparing a negative electrode paste including the hydrogen storage alloy powder, and applying this paste to the negative-electrode current collector and drying it.

### <Electrolyte Layer>

The electrolyte layer is a layer that contains an aqueous electrolytic solution and is formed between the positive electrode and the negative electrode. Here, the aqueous electrolytic solution refers to an electrolytic solution that uses mainly water as the solvent, and this solvent may include components other than water. The ratio of water to the entire solvent of the electrolytic solution should be 50 mol % or more, and may be 70 mol % or more, or may be 90 mol % or more, or may be 100 mol %.

It is preferable that the aqueous electrolytic solution be an aqueous alkaline solution. Examples of the solute of the aqueous alkaline solution include potassium hydroxide (KOH) and sodium hydroxide (NaOH), and the solute may include LiOH. The concentration of the solute in the aqueous electrolytic solution is preferably 2 to 10 mol/L, and more preferably 3 to 9 mol/L, and even more preferably 4 to 8 mol/L. A commonly known additive that is adopted for electrolytic solutions for nickel-metal hydride batteries may be added to the aqueous electrolytic solution.

The electrolyte layer has the separator 3. Installing the separator 3 can effectively prevent short-circuiting. Examples of the separator 3 include a non-woven fabric and a porous membrane containing resin, such as polyethylene or polypropylene, that has undergone a sulfonation treatment.

### <Casing>

The casing 4 is a battery case (cell container) that houses the above-described positive electrode 1, negative electrode 2, and separators 3 and is filled with an electrolyte. The material of the casing 4 may be any material that remains stable relative to the electrolytic solution without being corroded, and that can hold a gas (oxygen or hydrogen) that is temporarily generated during charge and the electrolytic solution without letting them leak out, and, for example, a metal case or a resin case is commonly used. In the case of a laminated alkaline storage battery 10 having a laminated body in which pluralities of positive electrodes 1 and negative electrodes 2 are laminated with the separators 3 in between, the casing 4 may have a structure in which a periphery of the laminated body is sealed by a frame-shaped resin.

### <Battery Applications>

The alkaline storage battery 10 of the present invention is typically a secondary battery. Therefore, being repeatedly chargeable and dischargeable, this battery is suitable as an on-board battery, for example. In that case, the alkaline storage battery 10 is not limited to use as a battery for a hybrid electric vehicle that is a form in which the battery supplies electricity to a motor for driving the vehicle. The alkaline storage battery 10 may be applied in a form in which it supplies electricity to a starter motor for restarting an engine in an automobile having a start-stop function.

The secondary battery includes use of the secondary battery like a primary battery (use intended for only one discharge after charge). As for the shape of the battery, there are, for example, a coin type, a laminate type, a cylindrical type, and a rectangular type, and any shape may be adopted.

### [Vehicle]

The vehicle of the present invention is equipped with the alkaline storage battery that uses the above-described hydrogen storage alloy as the negative electrode as a source of supplying electricity to a motor. By using the alkaline storage battery of the present invention that is dramatically downsized and reduced in weight compared with conventional batteries, the vehicle of the present invention can achieve improvement in the kinematic performance, reduction of the fuel consumption, and extension of the range.

### EXAMPLES

### Example 1

Cells for evaluation including negative electrodes that respectively used alloys (hydrogen storage alloys) No. 1 to 70 having the component compositions shown in Tables 1-1 to 1-4 below as the negative-electrode active materials were produced by a procedure to be described below, and experiments to evaluate their characteristics were conducted.

Of the alloys shown in Tables 1-1 to 1-4, alloys No. 1 to 33 are examples of alloys that comply with the conditions of the present invention (Invention Examples), and alloys No. 34 to 70 are examples of alloys that do not meet the conditions of the present invention (Comparative Examples). Alloy No. 34 of Comparative Example was used as a reference alloy for evaluating the characteristics of the cells.

### (Production of Negative-Electrode Active Material)

Raw materials (La, Y, Ce, Sm, Nd, Pr, Gd, Zr, Mg, Ni, Co, Mn, Al, Fe, etc., each with a purity of 99% or more) of the alloys No. 1 to 70 shown in Tables 1-1 to 1-4 were melted in an argon atmosphere (Ar: 100 vol %, 0.1 MPa) using a high-frequency induction heating furnace and cast to obtain alloy ingots formed by the hydrogen storage alloys.

Next, a heat treatment was performed in which these alloy ingots were each held at a temperatures of the alloy's melting point Tₘ minus 50° C. (940 to 1130° C.) for ten hours in an argon atmosphere (Ar: 90 vol %, 0.1 MPa).

Thereafter, each heat-treated alloy ingot was roughly ground, then further roughly ground by a wet ball mill, finely ground until the mass-based 50% undersize fraction particle diameter D50 became 16 μm, and filtered to obtain a finely ground filtered product.

Thereafter, as the step of treating the hydrogen storage alloy with an aqueous alkaline solution, the following treatment was performed. To 50 parts by mass of the finely ground filtered product of Example 1, 50 parts by mass of an aqueous sodium hydroxide solution containing 48 mass % sodium hydroxide was added as the aqueous alkaline solution to obtain a suspension. This suspension was heated to 100° C. and held for two hours, and was then cooled to room temperature.

This suspension was left to stand and a supernatant fluid was removed to separate the hydrogen storage alloy from the aqueous alkaline solution. 800 parts by mass of water was poured onto the hydrogen storage alloy from above to water-wash the hydrogen storage alloy. Again, the suspension was left to stand and a supernatant fluid was removed to separate the hydrogen storage alloy from the aqueous alkaline solution.

Further, as the step of oxidizing the surface of the hydrogen storage alloy after the above-described step, the following treatment was performed. To the entire finely ground filtered product obtained in the previous paragraph, 25 parts by mass of a 10 mass % hydrogen peroxide solution was added, and the mixture was stirred for 20 minutes. 400 parts by mass of water was poured to water-wash the hydrogen storage alloy.

Again, the suspension was left to stand and a supernatant fluid was removed to separate the hydrogen storage alloy from the aqueous alkaline solution. 400 parts by mass of water was poured onto the hydrogen storage alloy from above to water-wash the hydrogen storage alloy. This filtered hydrogen storage alloy was used as the negative-electrode active material of the cell for evaluation.

As for the AB₅ alloy No. 34 to be used as a reference for the cells for evaluation, this alloy was wet-ground into a fine powder having a mass-based 50% undersize fraction particle diameter D50 of 25 μm to be used as a sample (negative-electrode active material) of the cell for evaluation.

### (Production of Cells for Evaluation)

97.8 parts by mass of the above-described negative-electrode active material, 1.5 parts by mass of an acrylic resin emulsion as a binder in solid form, 0.7 parts by mass of carboxymethylcellulose as a binder, and an appropriate amount of ion-exchanged water were mixed together to manufacture a slurry.

A 20 μm thick nickel foil was prepared as the negative-electrode current collector. The aforementioned slurry was applied to the surface of this nickel foil so as to form a film. The nickel foil with the slurry applied thereto was dried to remove water, and thereafter the nickel foil was pressed. Thus, a negative electrode was manufactured in which a negative-electrode active material layer is formed on the surface of the negative-electrode current collector.

As the positive-electrode active material, nickel hydroxide particles were prepared that were coated with a cobalt oxyhydroxide layer containing sodium and lithium and formed by a solid solution of zinc and cobalt. These particles served as the positive-electrode active material to be used for the cells for evaluation of Example 1.

94.3 parts by mass of the aforementioned positive-electrode active material, 1.0 part by mass of cobalt powder as a conduction aid, 3.5 parts by mass of acrylic resin emulsion as a binder in solid form, 0.7 parts by mass of carboxymethylcellulose as a binder, 0.5 parts by mass of Y₂O₃ as a positive electrode additive, and an appropriate amount of ion-exchanged water were mixed together to manufacture a slurry.

A 20 μm thick nickel foil was prepared as the positive-electrode current collector. The aforementioned slurry was applied to the surface of this nickel foil so as to form a film. The nickel foil with the slurry applied thereto was dried to remove water, and thereafter the nickel foil was pressed. Thus, a positive electrode was manufactured in which a positive-electrode active material layer was formed on the surface of the positive-electrode current collector. The amount of positive-electrode active material layer present on this positive-electrode current collector was 28 mg/cm², and the density of the positive-electrode active material layer was 2.9 g/cm³.

As the electrolytic solution, an aqueous solution was prepared in which the concentration of potassium hydroxide was 5.4 mol/L, the concentration of sodium hydroxide was 0.8 mol/L, the concentration of lithium hydroxide was 0.5 mol/L, and the concentration of Na₂WO₄ was 0.16 mol/L.

As the separator, a 104 μm thick polyolefin fiber non-woven fabric that had undergone a sulfonation treatment was prepared.

The separator was held between the positive electrode and the negative electrode to form a group of electrode plates. The group of electrode plates was disposed in a resin casing, and further the electrolytic solution was poured in, and the casing was sealed. Thus, cells for evaluation as nickel hydrogen batteries were manufactured.

### (Various Evaluations of Alloys)

In this Example, an X-ray diffraction measurement was performed on a powder ground from each alloy after the heat treatment. As for the X-ray diffraction measurement conditions, the powder ground to below a particle diameter of 75 μm was set in a sample holder, and with Cu as the target, the measurement was performed at a tube voltage of 40 kV, a tube current of 40 mA, a scanning speed of 0.5°/min, a scanning step of 0.02°, a dispersion slit (DS) of 1°, a scattering slit (SS) of 1°, without a receiving slit (RS), and using only a kβ filter.

Rietveld analysis was performed based on diffraction line data obtained by performing the X-ray diffraction measurement on the powder ground from each alloy. As a result, it was confirmed that in all of the alloys of Invention Examples No. 1 to 33, the main phase was a phase composed of an A₂B₇ phase, an A₅B₁₉ phase, or an AB₃ phase, with the main phase accounting for 70 mass % or more. In particular, it was confirmed that in all the alloys of Invention Examples except for the alloy of Invention Example No. 22, the two phases of the A₂B₇ phase and the A₅B₁₉ phase accounted for more than 70 mass %.

Using the same diffraction line data, the ratio of the diffraction intensity (ζ) of (101) plane of the AB₅ phase to the diffraction intensity (ε) of the strongest diffraction peak present in the range of the diffraction angle of 40 to 45° was evaluated. As a result, it was confirmed that in all the alloys of Invention Examples, ζ/ε 0.08 held true.

The PCT characteristics of each alloy were evaluated by the following procedure. First, a lump of the hydrogen storage alloy was ground, and the particle size of the alloy particles formed by the ground hydrogen storage alloy was adjusted by a sieve with openings of 150 μm or more but 1 mm or less in the same manner as described above. The alloy particles of the ground hydrogen storage alloy were charged into a PCT measurement device, and evacuation (0.01 MPa or less) was performed at 80° C. for one hour.

Next, while the temperature was maintained, 3 MPa of a hydrogen gas was applied and held for 3.5 hours to make the hydrogen storage alloy store the hydrogen, and thereafter evacuation was performed for one hour to make the hydrogen storage alloy desorb the hydrogen. Thus, an activation treatment was performed.

Thereafter, for the alloys of Invention Examples, a hydrogen storage-desorption measurement (PCT characteristics evaluation) was performed in a range of the hydrogen pressure of 0.01 to 1 MPa. Tables 1-1 to 1-4 show the hydrogen storage capacity during application of 1 MPa as H/M, and a calculated value of Relational Expression (A) [log(P0.7/P0.3)]/0.4 as the plateau slope B.

As is clear from these tables, the alloys of Invention Examples each have the plateau slope B within a range from 1.3 to 3.0.

An evaluation of the crackability of each alloy due to repeated hydrogen storage and desorption is as follows. A lump of each hydrogen storage alloy was ground to obtain alloy particles of the hydrogen storage alloy. Thereafter, the particle size of the alloy particles of the hydrogen storage alloy was adjusted such that the particles remained over a sieve with 150 μm openings and became 1 mm or less. Seven grams of the hydrogen storage alloy formed by the alloy particles was charged into a measurement holder of a pressure-composition-temperature (PCT) evaluation device, and evacuation (0.01 MPa or less) was performed at 80° C. for one hour. Then, while the temperature was maintained, a hydrogen storage-desorption measurement (PCT characteristics evaluation) was performed in a range of the hydrogen pressure of 0.01 to 3 MPa.

Thereafter, evacuation (0.01 MPa or less) is performed for one hour, and a hydrogen gas is introduced up to 3 MPa and held for one hour to make the hydrogen storage alloy almost fully store the hydrogen. Then, evacuation (0.01 MPa or less) is performed for one hour to make the alloy desorb the hydrogen. This cycle is repeated three times.

Finally, as in the first cycle, the hydrogen storage-desorption measurement (PCT characteristics evaluation) is performed in the range of the hydrogen pressure of 0.01 to 3 MPa. After this hydrogen storage-desorption cycle was performed five times, the hydrogen storage alloy powder was taken out and a particle size distribution measurement was performed. Tables 1-1 to 1-4 show the value of the volume mean particle diameter MV of the alloy particles composing the finely pulverized hydrogen storage alloy after the repeated hydrogen storage and desorption. As listed in these tables, the alloy particles of the hydrogen storage alloys according to the present invention exhibit values of the mean particle diameter of 75 μm or more.

TABLE 1-1

| Alloy No. | Component composition of hydrogen storage alloy | H/M | P0.5 | B | ζ/ε | MV[um] |
|---|---|---|---|---|---|---|
| 1 | (La_{0.96}Y_{0.01}Ce_{0.02}Sm_{0.01})_{0.76}Mg_{0.24}Ni_{3.337}Al_{0.11}Cr_{0.003} | 0.95 | 0.048 | 2.10 | 0.03 | 87.1 |
| 2 | (La_{0.87}Y_{0.03}Ce_{0.01}Sm_{0.09})_{0.77}Mg_{0.23}N_{13.307}Al_{0.09}Cr_{0.003} | 0.96 | 0.055 | 2.43 | 0.02 | 94.1 |
| 3 | (La_{0.945}Y_{0.02}Ce_{0.025}Sm_{0.01})_{0.76}Mg_{0.24}N_{13.305}Al_{0.09}Cr_{0.003} | 0.95 | 0.038 | 2.32 | 0.02 | 91.8 |
| 4 | (La_{0.915}Y_{0.05}Ce_{0.025}Sm_{0.0})_{0.76}Mg_{0.24}Ni_{3.305}Al_{0.09}Cr_{0.003} | 0.97 | 0.050 | 1.88 | 0.02 | 82.5 |
| 5 | (La_{0.825}Y_{0.10}Ce_{0.005}Sm_{0.7})_{0.77}Mg_{0.23} N_{13.275}Al_{0.09}Cr_{0.003} | 0.98 | 0.061 | 2.02 | 0.00 | 85.4 |
| 6 | (La_{0.91}Y_{0.07}Ce_{0.01}Sm_{0.01})_{0.77}Mg_{0.23}Ni_{3.3275}Al_{0.09}Cr_{0.005} | 0.96 | 0.032 | 2.58 | 0.02 | 97.0 |
| 7 | (La_{0.90}Y_{0.03}Ce_{0.0}Sm_{0.06})_{0.77}Mg_{0.23}Ni_{3.305}Al_{0.09}Cr_{0.005} | 0.96 | 0.045 | 2.44 | 0.00 | 94.1 |
| 8 | (La_{0.89}Y_{0.05}Ce_{0.01}Sm_{0.05})_{0.77}Mg_{0.23} N_{13.305}Al_{0.09}Cr_{0.005} | 0.96 | 0.056 | 2.10 | 0.02 | 87.1 |
| 9 | (La_{0.90}Y_{0.03} Ce_{0.05}Sm_{0.1})_{0.77} Mg_{0.23} Ni_{3.305}Al_{0.12}Cr_{0.005} | 0.95 | 0.056 | 1.90 | 0.02 | 83.1 |
| 10 | (La_{0.87}Y_{0.03}Ce_{0.09}Sm_{0.01})_{0.77}Mg_{0.23}Ni_{3.305}Al_{0.12}Cr_{0.005} | 0.95 | 0.062 | 1.73 | 0.03 | 79.6 |
| 11 | (La_{0.90}Y_{0.03}Ce_{0.01}Sm_{0.06})_{0.77}Mg_{0.23}N_{13.27}Al_{0.09}Cr_{0.04} | 0.97 | 0.035 | 2.07 | 0.03 | 86.6 |
| 12 | (La_{0.90}Y_{0.03}Ce_{0.01}Sm_{0.06})_{0.77}Mg_{0.23}Ni_{3.28}Al_{0.09}Cr_{0.02} | 0.96 | 0.030 | 1.93 | 0.02 | 83.7 |
| 13 | (La_{0.90}Y_{0.03}Ce_{0.02}Sm_{0.05})_{0.73}Mg_{0.26}Ni_{3.325}Al_{0.08} Cr_{0.005} | 0.99 | 0.062 | 2.07 | 0.04 | 86.6 |
| 14 | (La_{0.90}Y_{0.03}Ce_{0.02}Sm_{0.05})_{0.80}Mg_{0.20}Ni_{3.345}Al_{0.07}Cr_{0.005} | 0.95 | 0.050 | 2.21 | 0.03 | 89.5 |
| 15 | (La_{0.82}Y_{0.08}Ce_{0.01}Sm_{0.09})_{0.85}Mg_{0.15}N_{13.375}Al_{0.06}Cr_{0.005} | 0.96 | 0.038 | 2.71 | 0.02 | 99.9 |
| 16 | (La_{0.925}Y_{0.05}Ce_{0.025})_{0.75}Mg_{0.25}N_{13.448}Al_{0.09}Cr_{0.012} | 1.00 | 0.065 | 1.57 | 0.05 | 76.2 |
| 17 | (La_{0.95}Y_{0.03}Ce_{0.02})_{0.81}Mg_{0.19}Ni_{3.655}Al_{0.09}Cr_{0.005} | 1.01 | 0.110 | 1.59 | 0.05 | 78.4 |
| 18 | (La_{0.95}Y_{0.03}Ce_{0.02})_{0.83}Mg_{0.17}Ni_{3.605}Al_{0.09}Cr_{0.005} | 0.98 | 0.070 | 1.98 | 0.03 | 88.2 |
| 19 | (La_{0.96}Y_{0.02}Ce_{0.02})_{0.83}Mg_{0.17}Ni_{3.555}Al_{0.09}Cr_{0.005} | 0.98 | 0.063 | 2.45 | 0.02 | 93.5 |
| 20 | (La_{0.92}Y_{0.03}Ce_{0.02}Sm_{0.03})_{0.81}Mg_{0.19}Ni_{3.505}Al_{0.09}Cr_{0.005} | 0.99 | 0.102 | 2.12 | 0.02 | 92.4 |

TABLE 1-2

| Alloy No. | Component composition of hydrogen storage alloy | H/M | P0.5 | B | ζ/ε | MV[um] |
|---|---|---|---|---|---|---|
| 21 | (La_{0.925}Y_{0.05}Ce_{0.025})_{0.75}Mg_{0.25}Ni_{3.398}Al_{0.09}Cr_{0.012} | 0.99 | 0.061 | 1.73 | 0.02 | 82.4 |
| 22 | (La_{0.94}Y_{0.025}Ce_{0.025}Sm_{0.01})_{0.75}Mg_{0.25}Ni_{3.148}Al_{0.09}Cr_{0.012} | 0.94 | 0.025 | 2.61 | 0.00 | 97.6 |
| 23 | (La_{0.86}Y_{0.04}Ce_{0.03}Sm_{0.07})_{0.80}Mg_{0.20}Ni_{3.362}Al_{0.03}Cr_{0.008} | 0.98 | 0.047 | 2.81 | 0.03 | 104.0 |
| 24 | (La_{0.86}Y_{0.04}Ce_{0.03}Sm_{0.07})_{0.80}Mg_{0.20}Ni_{3.362}Al_{0.06}Cr_{0.008} | 0.97 | 0.049 | 2.69 | 0.02 | 99.3 |
| 25 | (La_{0.85}Y_{0.07}Ce_{0.02}Sm_{0.0})_{0.80}Mg_{0.20}Ni_{3.336}Al_{0.10}Cr_{0.004} | 0.97 | 0.036 | 2.10 | 0.04 | 87.1 |
| 26 | (La_{0.85}Y_{0.07}Ce_{0.02}Sm_{0.06})_{0.80}Mg_{0.20}Ni_{3.336}Al_{0.13}Cr_{0.004} | 0.95 | 0.030 | 1.76 | 0.05 | 80.2 |
| 27 | (La_{0.96}Y_{0.02}Ce_{0.02})_{0.77}Mg_{0.23}Ni_{3.265}Fe_{0.10}Al_{0.09}Cr_{0.005} | 0.96 | 0.023 | 1.72 | 0.03 | 82.2 |
| 28 | (La_{0.975}Y_{0.02}Ce_{0.005})_{0.80}Mg_{0.20}Ni_{3.545}Fe_{0.02}Al_{0.09}Cr_{0.005} | 0.97 | 0.050 | 1.89 | 0.04 | 84.5 |
| 29 | (La_{0.95}Y_{0.02}Ce_{0.02}Sm_{0.01})_{0.87}Mg_{0.13}Ni_{3.645}Fe_{0.25}Cr_{0.005} | 0.93 | 0.027 | 2.60 | 0.03 | 98.0 |
| 30 | (La_{0.90}Y_{0.03}Ce_{0.03}Sm_{0.04})_{0.77}Mg_{0.23}Ni_{3.01}Fe_{0.30}Al_{0.09} | 0.93 | 0.025 | 1.98 | 0.04 | 92.9 |
| 31 | (La_{0.975}Y_{0.015}Ce_{0.01})_{0.80}Mg_{0.20}Ni_{3.545}Fe_{0.05}Al_{0.09}Cr_{0.005} | 0.97 | 0.058 | 1.68 | 0.03 | 82.8 |
| 32 | (La_{0.91}Y_{0.03}Ce_{0.03}Sm_{0.03})_{0.77}Mg_{0.23}Ni_{3.21}Al_{0.03}Fe_{0.16} | 0.95 | 0.030 | 2.00 | 0.04 | 86.8 |
| 33 | (La_{0.91}Y_{0.03}Ce_{0.03}Sm_{0.03})_{0.77}Mg_{0.23}Ni_{3.21}Fe_{0.19} | 0.95 | 0.028 | 2.24 | 0.02 | 92.9 |
| 34 | La_{0.9}Ce_{0.1}Ni_{4.0}Co_{0.5}Mn_{0.2}Al_{0.4} | 0.82 | 0.048 | 0.42 | — | 40.2 |
| 35 | La_{0.66}Mg_{0.34}Ni_{3.15}Al_{0.12} | 0.92 | 0.070 | 1.18 | 0.03 | 51.9 |
| 36 | (La_{0.90}Y_{0.03}Sm_{0.07})_{0.77}Mg_{0.23}Ni_{3.45}Al_{0.090}Cr_{0.08} | 0.92 | 0.057 | 1.35 | 0.10 | 69.8 |
| 37 | (La_{0.72}Y_{0.2}Ce_{0.02}Sm_{0.06})_{0.80}Mg_{0.20}Ni_{3.336}Al_{0.11}Cr_{0.004} | 0.93 | 0.070 | 1.28 | 0.06 | 67.0 |
| 38 | (La_{0.64}Y_{0.08}Ce_{0.10}Sm_{0.18})_{0.77}Mg_{0.22}Ni_{3.275}Al_{0.09}Cr_{0.003} | 0.95 | 0.080 | 1.26 | 0.05 | 62.0 |
| 39 | (La_{0.825}Y_{0.10}Ce_{0.005}Sm_{0.07})_{0.77}Mg_{0.22}Ni_{3.197}Al_{0.2}Cr_{0.003} | 0.90 | 0.025 | 1.37 | 0.11 | 64.6 |
| 40 | (La_{0.94}Y_{0.025}Ce_{0.025}Sm_{0.01})_{0.75}Mg_{0.25}Ni_{3.05}Al_{0.09}Cr_{0.01} | 0.86 | 0.022 | 3.14 | 0.00 | 88.6 |

TABLE 1-3

| Alloy | Component composition of hydrogen storage alloy | H/M | P0.5 | B | ζ/ε | MV[um] |
|---|---|---|---|---|---|---|
| 41 | (La_{0.915}Y_{0.05}Ce_{0.025}Sm_{0.01})_{0.75}Mg_{0.25}Ni_{3.548}Al_{0.09}Cr_{0.012} | 0.96 | 0.087 | 1.20 | 0.10 | 54.8 |
| 42 | (La_{0.25}Sm_{0.73}Zr_{0.02})_{0.90}Mg_{0.10}Ni_{3.20}Al_{0.20} | 0.89 | 0.081 | 1.24 | 0.10 | 64.8 |
| 43 | La_{0.60}Sm_{0.30}Mg_{0.10}Ni_{3.70}Al_{0.10} | 0.94 | 0.066 | 1.20 | 0.12 | 58.0 |
| 44 | (La_{0.20}Pr_{0.39}Nd_{0.40}Zr_{0.01})_{0.84}Mg_{0.16}Ni_{3.15}Al_{0.20} | 0.88 | 0.105 | 1.38 | 0.06 | 68.4 |
| 45 | (La_{0.83}Y_{0.17})_{0.82}Mg_{0.18}Ni_{3.32}Co_{0.14}Mn_{0.09} | 0.92 | 0.023 | 1.20 | 0.10 | 62.4 |
| 46 | (La_{0.86}Y_{0.14})_{0.88}Mg_{0.12}Ni_{3.00}Co_{0.08}Mn_{0.08} | 0.87 | 0.015 | 1.22 | 0.00 | 78.0 |
| 47 | (La_{0.5}Y_{0.5})_{0.82}Mg_{0.18}Ni_{3.36}Mn_{0.18} | 0.88 | 0.090 | 1.39 | 0.05 | 52.0 |
| 48 | (La_{0.765}Y_{0.235})_{0.81}Mg_{0.19}Ni_{3.67}Al_{0.10} | 0.94 | 0.084 | 1.09 | 0.12 | 50.2 |
| 49 | (La_{0.20}Nd_{0.27}Sm_{0.18}Gd_{0.18}Y_{0.17})_{0.90}Mg_{0.10}Ni_{2.9}Al_{0.20}Co_{0.10} | 0.91 | 0.048 | 1.30 | 0.07 | 70.0 |
| 50 | (La_{0.4}Y_{0.6})_{0.88}Zr_{0.01}Mg_{0.11}Ni_{3.33}Al_{0.17} | 0.88 | 0.047 | 1.11 | 0.04 | 48.8 |
| 51 | (La_{0.2}Nd_{0.4}Sm_{0.39}Zr_{0.01})_{0.89}Mg_{0.11}N_{13.27}Al_{0.17}Cr_{0.01} | 0.90 | 0.087 | 1.55 | 0.04 | 73.2 |
| 52 | La_{0.717}Y_{0.13}Mg_{0.153}Ni_{3.48}Al_{0.15} | 0.92 | 0.022 | 1.28 | 0.10 | 55.8 |
| 53 | La_{0.3}Y_{0.1}Sm_{0.49}Mg_{0.11}Ni_{3.26}Al_{0.16} | 0.91 | 0.092 | 1.25 | 0.05 | 70.0 |
| 54 | (La_{0.73}Y_{0.12}Sm_{0.15})_{0.85}Mg_{0.15}Ni_{3.48}Al_{0.15} | 0.92 | 0.060 | 1.26 | 0.07 | 58.6 |
| 55 | (La_{0.76}Y_{0.12}Nd_{0.12})_{0.86}Mg_{0.14}Ni_{3.46}Al_{0.10}Co_{0.10}Mn_{0.10} | 0.90 | 0.027 | 1.16 | 0.12 | 66.6 |
| 56 | La_{0.60}Y_{0.35}Mg_{0.05}Ni_{3.50}Al_{0.12} | 0.91 | 0.012 | 1.20 | 0.11 | 50.6 |
| 57 | (La_{0.845}Y_{0.155})_{0.84}Mg_{0.16}Ni_{3.45}Al_{0.15} | 0.92 | 0.017 | 1.26 | 0.09 | 68.1 |
| 58 | (La_{0.501}Pr_{0.233}Nd_{0.249}Zr_{0.004}Y_{0.013})_{0.83}Mg_{0.17}Ni_{3.13}Al_{0.17}Co_{0.1} | 0.92 | 0.070 | 1.40 | 0.00 | 72.5 |
| 59 | (La_{0.975}Y_{0.025})_{0.82}Mg_{0.18}Ni_{3.55}Al_{0.18} | 0.90 | 0.023 | 1.25 | 0.10 | 56.8 |
| 60 | (La_{0.22}Nd_{0.30}Sm_{0.20}Gd_{0.20}Y_{0.08})_{0.90}Mg_{0.10}Ni_{3.18}Al_{0.12} | 0.90 | 0.095 | 1.53 | 0.02 | 72.0 |

TABLE 1-4

| Alloy No. | Component composition of hydrogen storage alloy | H/M | P0.5 | B | ζ/ε | MV[um] |
|---|---|---|---|---|---|---|
| 61 | (La_{0.83}Ce_{0.01}Y_{0.16})_{0.86}Mg_{0.14}Ni_{3.35}Co_{0.30}Al_{0.15} | 0.91 | 0.051 | 1.27 | 0.14 | 60.0 |
| 62 | La_{0.75}Y_{0.05}Mg_{0.20}Ni_{2.85}Mn_{0.10}Co_{0.55}Al_{0.10} | 0.94 | 0.059 | 1.24 | 0.10 | 73.2 |
| 63 | La_{0.63}Y_{0.20} Mg_{0.17}Ni_{3.1}Co_{0.30}Al_{0.10} | 0.91 | 0.047 | 1.24 | 0.06 | 55.5 |
| 64 | (La_{0.45}Nd_{0.45}Ce_{0.1})_{0.85}Mg_{0.15}Ni_{3.3}Al_{0.20} | 0.89 | 0.078 | 1.22 | 0.09 | 65.6 |
| 65 | La_{0.7}Mg_{0.3}Co_{0.45}Ni_{2.35}Fe_{0.20} | 0.80 | 0.032 | 3.28 | 0.00 | 100.1 |
| 66 | La_{2.0}Ni_{6.8}Al_{0.1}Fe_{0.1}(═LaNi_{3.4}Al_{0.05}Fe_{0.05}) | 0.83 | 0.012 | 1.84 | 0.00 | 115.5 |
| 67 | La_{0.55}Pr_{00.06}Nd_{0.19}Mg_{0.20}Ni_{3.27}Fe_{0.05}Al_{0.08} | 0.96 | 0.045 | 1.32 | 0.03 | 91.1 |
| 68 | Mm_{0.83}Mg_{0.17}Ni_{2.84}Al_{0.17}Co_{0.20}Fe_{0.10} | 0.97 | 0.130 | 2.85 | 0.02 | 78.8 |
| 69 | La_{0.80}Mg_{0.20}Ni_{2.85}Al_{0.11}Fe_{0.53} | 0.84 | 0.023 | 3.30 | 0.03 | 100.3 |
| 70 | (La_{0.6}Nd_{0.25}Sm_{0.1}Zr_{0.05})_{0.85}Mg_{0.15}Ni_{3.20}Fe_{0.10}Al_{0.15} | 0.96 | 0.088 | 2.00 | 0.05 | 74.2 |

### (Characteristics Evaluation of Cells)

Evaluation tests of the cells for evaluation based on the alloys No. 1 to 70 obtained as described above were performed by the following procedures. The evaluation temperature was 40° C. in all the tests. The results are collectively shown in Table 2-1 to Table 2-4.

### (1) Discharge Capacity of Electrode

Confirmation of the discharge capacity of an electrode of a working electrode was performed by the following procedure. After constant-current charge was performed for ten hours at a current value of 80 mA/g per active material of the working electrode, constant-current discharge was performed at a current value of 40 mA/g per active material of the working electrode. The condition for ending the discharge was that the potential of the working electrode was −0.5 V. This charge-discharge cycle was repeated ten times, and the maximum value of the discharge capacity was regarded as the discharge capacity of the electrode of the working electrode.

It was confirmed that the discharge capacity of the working electrode saturated and stabilized after the ten charge-discharge cycles. Using the discharge capacity of the AB₅ alloy No. 34 shown in Table 1-2 as a reference capacity, a ratio of the measured discharge capacity to this reference capacity was calculated by Relational Expression (2) below. Alloys of which this ratio was more than 1.15 were evaluated as excellent with a higher discharge capacity than the AB₅ alloy.

$$\begin{matrix}[ Mathematical Formula 4 ] & \\ Discharge capacity = \frac{( Discharge capacity of alloy being evaluated )}{( Discharge capacity of {AB}_{5} alloy ( No . 34 ) )} & ( 2 )\end{matrix}$$

### (2) Cycle Life Characteristics

Using each cell of which the discharge capacity of the electrode of the working electrode was confirmed in (1) Discharge Capacity of Electrode described above, the cycle life characteristics of the working electrode were obtained by the following procedure. When a current value required to complete, in one hour, charge or discharge of the discharge capacity of the electrode of the working electrode confirmed in (1) Discharge Capacity of Electrode described above is 1 C, performing constant-current charge and constant-current discharge at a current value of C/2 in a range of the charge rate of the working electrode of 20 to 80% is defined as one cycle. This cycle was repeated 300 times, and the discharge capacity after 300 cycles was measured and a capacity maintaining ratio was obtained by the following Relational Expression (3):

$$\begin{matrix}[ Mathematical Formula 5 ] & \\ Capacity maintaining ratio = \frac{( Discharge capacity in 100 th cycle )}{( Discharge capacity in 5 th cycle )} & ( 3 )\end{matrix}$$

For the evaluation of the cycle life characteristics, the capacity maintaining ratio after 300 cycles of the AB₅ alloy No. 34 shown in Table 1-2 was used as a reference capacity maintaining ratio, and a ratio to that ratio was calculated by Relational Expression (4) below. Alloys of which this ratio was more than 1.15 were evaluated as excellent with higher cycle life characteristics than the AB₅ alloy.

$$\begin{matrix}[ Mathematical Formula 6 ] & \\ Cycle life characteristics = \frac{( Capacity maintaining ratio after 300 cycles of alloy being measured )}{( Capacity maintaining ratio after 300 cycles of ABs alloy ( No . 34 ) )} & ( 4 )\end{matrix}$$

### (Alloy Cost)

For the alloy cost, a raw material cost for manufacturing each of the alloys having the component compositions listed in Tables 1-1 to 1-4 by melting metals with a purity of 99% was relatively evaluated. Alloys that were 10% or more inexpensive than alloy No. 34 (reference cost) were evaluated as excellent; those 0 to 10% more inexpensive as good; those more than 0 to 10% more expensive as fair; and those 10% or more expensive as poor. The results are shown in Tables 2-1 to 2-4. As is clear from these tables, the hydrogen storage alloys of Invention Examples exhibit favorable values in aspects including the characteristics and the cost.

TABLE 2

| | Electrode characteristics | | | |
|---|---|---|---|---|
| | Discharge | Cycle life | | |
| | capacity | characteristics | | |
| Alloy | (ratio to alloy | (ratio to alloy | | |
| No. | No. 34) | No. 34) | Cost | Remarks |
| 1 | 1.19 | 1.30 | Excellent | Invention Example |
| 2 | 1.18 | 1.24 | Excellent | Invention Example |
| 3 | 1.17 | 1.25 | Excellent | Invention Example |
| 4 | 1.19 | 1.26 | Excellent | Invention Example |
| 5 | 1.20 | 1.24 | Excellent | Invention Example |
| 6 | 1.18 | 1.22 | Excellent | Invention Example |
| 7 | 1.21 | 1.36 | Excellent | Invention Example |
| 8 | 1.20 | 1.35 | Excellent | Invention Example |
| 9 | 1.20 | 1.25 | Excellent | Invention Example |
| 10 | 1.18 | 1.26 | Excellent | Invention Example |
| 11 | 1.18 | 1.17 | Excellent | Invention Example |
| 12 | 1.21 | 1.30 | Excellent | Invention Example |
| 13 | 1.24 | 1.35 | Excellent | Invention Example |
| 14 | 1.21 | 1.24 | Excellent | Invention Example |
| 15 | 1.21 | 1.23 | Excellent | Invention Example |
| 16 | 1.23 | 1.29 | Excellent | Invention Example |
| 17 | 1.25 | 1.20 | Excellent | Invention Example |
| 18 | 1.21 | 1.24 | Excellent | Invention Example |
| 19 | 1.20 | 1.27 | Excellent | Invention Example |
| 20 | 1.24 | 1.28 | Excellent | Invention Example |
| 21 | 1.24 | 1.24 | Excellent | Invention Example |
| 22 | 1.18 | 1.38 | Excellent | Invention Example |
| 23 | 1.19 | 1.38 | Excellent | Invention Example |
| 24 | 1.22 | 1.28 | Excellent | Invention Example |
| 25 | 1.20 | 1.28 | Excellent | Invention Example |
| 26 | 1.16 | 1.25 | Excellent | Invention Example |
| 27 | 1.11 | 1.68 | Excellent | Invention Example |
| 28 | 1.16 | 1.48 | Good | Invention Example |
| 29 | 1.06 | 1.45 | Excellent | Invention Example |
| 30 | 1.10 | 1.73 | Excellent | Invention Example |
| 31 | 1.16 | 1.48 | Excellent | Invention Example |
| 32 | 1.12 | 1.61 | Excellent | Invention Example |
| 33 | 1.12 | 1.59 | Excellent | Invention Example |
| 34 | 1.00 | 1.00 | — | Comparative Example |
| | | | | (reference value) |
| 35 | 1.11 | 1.13 | Excellent | Comparative Example |
| 36 | 1.13 | 1.10 | Excellent | Comparative Example |
| 37 | 1.14 | 1.12 | Good | Comparative Example |
| 38 | 1.16 | 1.12 | Excellent | Comparative Example |
| 39 | 1.11 | 1.15 | Excellent | Comparative Example |
| 40 | 1.08 | 1.18 | Excellent | Comparative Example |
| 41 | 1.17 | 1.06 | Excellent | Comparative Example |
| 42 | 1.07 | 1.14 | Good | Comparative Example |
| 43 | 1.15 | 1.05 | Good | Comparative Example |
| 44 | 1.07 | 1.18 | Poor | Comparative Example |
| 45 | 1.13 | 1.02 | Good | Comparative Example |
| 46 | 1.09 | 1.04 | Good | Comparative Example |
| 47 | 1.11 | 1.08 | Fair | Comparative Example |
| 48 | 1.16 | 1.02 | Good | Comparative Example |
| 49 | 1.10 | 1.15 | Poor | Comparative Example |
| 50 | 1.08 | 1.05 | Excellent | Comparative Example |
| 51 | 1.10 | 1.15 | Poor | Comparative Example |
| 52 | 1.11 | 1.10 | Excellent | Comparative Example |
| 53 | 1.13 | 1.08 | Good | Comparative Example |
| 54 | 1.13 | 1.10 | Good | Comparative Example |
| 55 | 1.12 | 1.13 | Poor | Comparative Example |
| 56 | 1.10 | 1.13 | Fair | Comparative Example |
| 57 | 1.12 | 1.14 | Excellent | Comparative Example |
| 58 | 1.12 | 1.15 | Poor | Comparative Example |
| 59 | 1.10 | 1.12 | Excellent | Comparative Example |
| 60 | 1.11 | 1.15 | Poor | Comparative Example |
| 61 | 1.12 | 1.09 | Fair | Comparative Example |
| 62 | 1.15 | 1.08 | Poor | Comparative Example |
| 63 | 1.12 | 1.15 | Fair | Comparative Example |
| 64 | 1.08 | 1.15 | Poor | Comparative Example |
| 65 | 0.92 | 1.35 | Fair | Comparative Example |
| 66 | 0.89 | 0.35 | Excellent | Comparative Example |
| 67 | 1.11 | 1.32 | Poor | Comparative Example |
| 68 | 1.12 | 1.23 | Fair | Comparative Example |
| 69 | 1.01 | 1.35 | Excellent | Comparative Example |
| 70 | 1.12 | 1.28 | Poor | Comparative Example |

As is clear from Tables 2-1 to 2-4, it can be seen that the alloys No. 1 to 33 of Invention Examples have well-balanced excellent characteristics, with the evaluation values for both the discharge capacity and the cycle life characteristics being 1.15 or more relative to those of the AB₅ alloy No. 34. By contrast, it can be seen that the evaluation values for either of the characteristics of the alloys No. 34 to 70 of Comparative Examples are less than 1.15, indicating that these hydrogen storage alloys are ones with poorly balanced battery characteristics.

In the present invention, the presence of the surface-treated layer of the alloy specified for improving the durability and the characteristics of the alloy itself were discovered in combination, which led to completion of the invention. Invention Examples are all alloys containing an appropriate amount of Y, whereas Comparative Examples are alloys of which the content of Y is outside the range of appropriate amount or alloys that do not contain Y, and all are alloys to which Y₂O₃ was externally added.

The alloys containing Y outside the range of appropriate amount are themselves prone to cracking under the influence of hydrogen storage and desorption, and a surface-treated layer that provides the alloy with durability cannot be sufficiently formed. In addition to these alloys, the alloys that do not contain Y are sometimes improved in durability by the effect of the externally added Y₂O₃, but not so far as to reach the required level of durability. This is presumably because a layer has been formed inside these alloys that is different from the surface-treated layer that is formed on an alloy containing an appropriate amount of Y.

### Example 2

As Examples of Invention, a predetermined treatment was performed on the hydrogen storage alloys No. 7, 8, 21, and 25 shown in Tables 1-1 and 1-2, and then a powder surface analysis and an evaluation of a pore diameter distribution were performed.

In the powder surface analysis, the surface-treated layer formed on the alloy surface was observed using a transmission electron microscope. Specifically, each of the hydrogen storage alloys obtained by performing the predetermined treatment on the samples of No. 7, 8, 21, and 25 was mixed into epoxy resin, and then the epoxy resin was cured at 120° C. for 30 minutes to embed the alloy in the resin. Thereafter, by a flaking process using an argon beam, a sample in a form of flakes of 100 nm or less was obtained.

For the flaking process, an ion slicer (EM-09100IS) manufactured by JEOL Ltd. was used. The flaky sample was thinly ground at an acceleration voltage of 6 kV until pores of a few μm open therein, and then finishing was performed at an acceleration voltage of 1.0 kV for 15 minutes.

For the obtained flaky sample, the surface-treated layer formed on the alloy surface was observed using a transmission electron microscope (JEM-2100F manufactured by JEOL Ltd.) at an acceleration voltage of 200 kV. Further, using an energy dispersive X-ray emission spectrometer (JED-2300 manufactured by JEOL Ltd.) installed in the device, an analysis of elements included in the surface-treated layer was performed.

As a result, it was confirmed that on the surface of the hydrogen storage alloy, a layer of an oxide or a hydroxide at least partially containing Y was present on and in close contact with the surfaces of the alloy particle.

Further, it was confirmed that the thickness of this surface-treated layer in the hydrogen storage alloy No. 7 was 220 nm, and that the thickness of the surface-treated layer became smaller as the amount of Y contained in the hydrogen storage alloy increased.

On the other hand, the pore diameter distribution was evaluated as follows. The hydrogen storage alloys No. 7, 8, 21, and 25 having undergone the aforementioned predetermined treatment were vacuum-dried at 100° C. for two hours, and then a nitrogen adsorption-desorption isothermal line at a liquid nitrogen temperature (77.3 K) of each hydrogen storage alloy was measured using a fully automatic gas adsorption measuring device (AS1-MP, Anton Paar GmbH). The nitrogen adsorption amount per unit weight of the hydrogen storage alloy on the adsorption-desorption isothermal line was calculated so as to be represented by a volume of gaseous nitrogen in the standard state. The total pore volume was calculated from Relational Expression (B), with the nitrogen adsorption amount at a relative pressure (p/p0=0.99) on the adsorption-desorption isothermal line as V [Ncm³/g].

Further, using the adsorption-desorption isothermal line, the pore diameter distribution in a mesopore region was analyzed by the BJH method, and the pore diameter distribution in a micropore to mesopore region was analyzed by the DFT method, and the mean pore diameter was calculated. As a result, the total pore volume was 0.0046 cm³/g and the mean pore diameter was 25.9 nm. The BET specific surface area was 0.702 m²/g. In the hydrogen storage alloys No. 8, 21, and 25, the total pore volumes assumed values of 0.0040 to 0.0125 cm³/g and the mean pore diameters assumed values of 10 to 35 nm. All the alloys exhibited BET specific surface areas of 0.790 m²/g or more. These measurement results indicate the features of the porous texture of the layer of an oxide or a hydroxide containing Y at least partially, i.e., the surface-treated layer that is formed on the surface of the hydrogen storage alloy and is in close contact with the alloy particle surfaces.

As Comparative Examples, hydrogen storage alloys of Comparative Examples were obtained by the same method as described above, except that No. 43 and 48 shown in Tables 1-3 were used. On the surface of each hydrogen storage alloy of Comparative Example, a layer of an oxide or a hydroxide containing at least partially Y and in close contact with the surface was not present, and there was a portion exceeding 500 nm in the surface-treated layer. Both alloys were outside the ranges of the total pore volume, the mean pore diameter, and the BET specific surface area of the present invention.

### (Battery Characteristics)

A nickel hydrogen battery adjusted to a state-of-charge (SOC) of 60% using the hydrogen storage alloy having undergone the aforementioned predetermined treatment was discharged at a 1C rate for five seconds under the condition of 25° C. The discharge resistance was calculated based on Ohm's law from a voltage change amount between before and after the discharge and a current value during the discharge.

The discharge capacity was confirmed in accordance with the method of Example 1. Performing constant-current charge and constant-current discharge at a current value of C/3 was regarded as one cycle (the end voltage was 1.0 V), and 1800 cycles of charge and discharge were performed. Thereafter, the discharge capacity after the 1800 cycles was measured, and the capacity maintaining ratio was obtained by the following Relational Expression (5):

$$\begin{matrix}[ Mathematical Formula 7 ] & \\ Capacity Maitaining ratio = \frac{( Discharge capacity in 1800 th cycle )}{( Discharge capacity in first cycle )} & ( 5 )\end{matrix}$$

Table 3 shows the results of the discharge resistance and the capacity maintaining ratio having been described above.

TABLE 3

| | Discharge | Capacity | |
|---|---|---|---|
| Alloy No. | resistance [Ω] | maintaining ratio | Remarks |
| 7 | 0.16 | 94.9 | Invention Example |
| 8 | 0.16 | 94.9 | Invention Example |
| 21 | 0.17 | 95.0 | Invention Example |
| 25 | 0.15 | 94.8 | Invention Example |
| 43 | 0.15 | 87.2 | Comparative Example |
| 48 | 0.15 | 86.5 | Comparative Example |

As is clear from Table 3, the negative-electrode active materials obtained from Invention Examples, i.e., the alloys No. 7, 8, 21, and 25 have high capacity maintaining ratios after the durability test and at the same time exhibit low discharge resistances. Thus, the negative-electrode active materials using the alloys of Invention Examples can be said to have achieved compatibility between the output characteristics and the durability at a high level.

For these samples, after the durability was evaluated, the surface states of the alloys were evaluated in the same manner. As a result, in Invention Examples, the surface state of the above-described embodiment similar to that before the evaluation of the durability was recognized. On the other hand, in Comparative Examples, the surface state of the above-described embodiment was not recognized. It can be said that when the case where an appropriate amount of Y is included inside the alloy and the case where Y is externally added as Y₂O₃ are compared, the effect of Y on the durability is different.

### INDUSTRIAL APPLICABILITY

The hydrogen storage alloy of the present invention is superior in both discharge capacity and cycle life characteristics to the conventionally used AB₅-type hydrogen storage alloy. Therefore, this hydrogen storage alloy is not only suitable as a negative electrode material of alkaline storage batteries for applications in hybrid electric vehicles and start-stop vehicles, but also can be suitably used for alkaline storage batteries for pure electric vehicles.

### REFERENCE SIGNS LIST

1: Positive electrode
2: Negative electrode
3: Separator
4: Casing (battery case)
10: Alkaline storage battery

1. A hydrogen storage alloy used for an alkaline storage battery, characterized in that the hydrogen storage alloy has a main phase combining crystal structures of an A₂B₇-type structure, an A₅B₁₉-type structure, and an AB₃-type structure and meets conditions of General Formula (1) below: 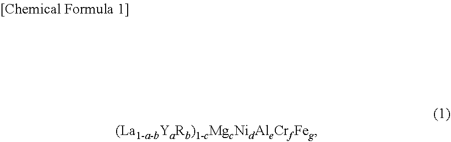
where R and the suffixes a, b, c, d, e, f, and g are as follows:
R: one or both of Sm and Ce,
$$\begin{matrix}0 < a \leq 0.12 , \\ 0 \leq b \leq 0.12 , \\ 0.13 \leq c \leq 0.27 , \\ 3.2 \leq d + e + f + g \leq 3.75 , \\ 0 \leq e \leq 0.14 , \\ 0 \leq f \leq 0.05 , and \\ 0 \leq g \leq 0.35 .\end{matrix}$$

2. The hydrogen storage alloy for an alkaline storage battery according to claim 1, wherein General Formula (1) further meets the following condition:
the suffixes a, b, c, d, e, f, and g in General Formula (1) are as follows:
$$\begin{matrix}0 < a \leq 0.10 , \\ 0 < b \leq 0.10 , \\ 0.14 \leq c \leq 0.26 , \\ 3.25 \leq d + e + f + g \leq 3.7 , \\ 0 \leq e \leq 0.13 , \\ 0 \leq f \leq 0.04 , and \\ 0 < g \leq 0.30 .\end{matrix}$$

3. The hydrogen storage alloy for an alkaline storage battery according to claim 1, wherein the hydrogen storage alloy has a hydrogen storage capacity H/M (H is the number of atoms of hydrogen, M is the number of atoms of metal) of 0.94 or more when a hydrogen pressure is applied up to 1 MPa at 80° C., and wherein a hydrogen pressure P0.5 when the hydrogen storage capacity H/M during hydrogen desorption is 0.5 is 0.025 MPa or more but 0.12 MPa or less.

4. The hydrogen storage alloy for an alkaline storage battery according to claim 1, wherein the hydrogen storage alloy of which a particle size has been adjusted to be within a range of 150 μm or more but 1 mm or less has a volume mean particle diameter MV of 75 μm or more after repeated hydrogen storage and desorption,
the volume mean particle diameter MV being measured after repeating five times a cycle in which, for hydrogen storage, a hydrogen pressure is applied up to 3 MPa at 80° C. and held for one hour and, for hydrogen desorption, evacuation is performed and the pressure is reduced to or below 0.01 MPa at 80° C. and held for one hour.

5. The hydrogen storage alloy for an alkaline storage battery according to claim 1, wherein, in hydrogen storage-desorption characteristics at 80° C. of the hydrogen storage alloy, a value calculated as a plateau slope B during hydrogen desorption after storage that is represented by Relational Expression (A) below is within a range of 1.3 or more but 3.0 or less:
$$\begin{matrix}[ Mathematical Formula 1 ] & \\ Plateau slope B = [ log ( P 0.7 / P 0.3 ) ] / 0.4 , & ( A )\end{matrix}$$
where P0.7 is a hydrogen pressure [MPa] when the hydrogen storage capacity (H/M)=0.7, and P0.3 is a hydrogen pressure [MPa] when the hydrogen storage capacity (H/M)=0.3.

6. The hydrogen storage alloy for an alkaline storage battery according to claim 5, wherein, in an X-ray diffraction measurement of the hydrogen storage alloy using Cu-Kα radiation as an X-ray source, a ratio ζ/ε of diffraction intensity ζ of (101) plane of an AB₅ phase to diffraction intensity ε of a strongest diffraction peak present in a range of a diffraction angle 20 of 40 to 45° is 0.08 or less.

7. The hydrogen storage alloy for an alkaline storage battery according to claim 1, wherein, in the hydrogen storage alloy, a layer of an oxide or a hydroxide containing Y is present on at least part of a surface of the hydrogen storage alloy.

8. The hydrogen storage alloy for an alkaline storage battery according to claim 7, wherein, in the hydrogen storage alloy, the layer of an oxide or a hydroxide containing Y that is present on at least part of the surface of the hydrogen storage alloy has a thickness of 500 nm or smaller where the layer is in close contact with surfaces of alloy particles.

9. The hydrogen storage alloy for an alkaline storage battery according to claim 7, wherein an oxide or a hydroxide that is present on at least part of the surface of the hydrogen storage alloy is composed mainly of a rare earth element included in the hydrogen storage alloy.

10. The hydrogen storage alloy for an alkaline storage battery according to claim 1, wherein a BET specific surface area of the hydrogen storage alloy in which an oxide or a hydroxide is present on at least part of the surface of the hydrogen storage alloy is more than 0.5 m²/g.

11. The hydrogen storage alloy for an alkaline storage battery according to claim 10, wherein, further, a pore volume is 0.013 cm³/g or less and a mean pore diameter is 40 nm or less.

12. An alkaline storage battery that uses the hydrogen storage alloy according to claim 1 for a negative electrode, characterized in that the alkaline storage battery is installed in a hybrid electric vehicle having a motor as a drive source and supplies electricity to the motor.

13. An alkaline storage battery that uses the hydrogen storage alloy according to claim 1 for a negative electrode, characterized in that the alkaline storage battery is installed in an automobile having a start-stop function that starts an engine by a starter motor, and supplies electricity to the starter motor.

14. A vehicle, characterized in that the vehicle has, as a source of electricity to be supplied to a motor, an alkaline storage battery that uses the hydrogen storage alloy according to claim 1 for a negative electrode.
